(19) United States
(12) Patent Application Publication
(10) Pub. No.: US 2022/0410274 A1
(43) Pub. Date: Dec. 29, 2022

(54) METHOD OF COMPENSATING FOR SINTERING WARPAGE DUE TO POWDER SPREADING DENSITY VARIATIONS IN BINDER JET 3D PRINTING

(71) Applicant: Desktop Metal, Inc., Burlington, MA (US)

(72) Inventor: Andrew Fiske Roberts, Chelsea, MA (US)

(73) Assignee: Desktop Metal, Inc., Burlington, MA (US)

(21) Appl. No.: 17/898,322

(22) Filed: Aug. 29, 2022

Related U.S. Application Data
(63) Continuation-in-part of application No. 16/880,319, filed on May 21, 2020.
(60) Provisional application No. 62/902,189, filed on Sep. 18, 2019.
(60) Provisional application No. 62/850,957, filed on May 21, 2019.

(51) Int. Cl. B22F 10/85; B33Y 10/00; B33Y 50/02; B22F 10/14; G06T 17/20; G06T 19/20; G06F 30/20

(52) U.S. Cl. CPC B22F 10/85; B33Y 10/00; B33Y 50/02; B22F 10/14; G06T 17/20; G06T 19/20; G06F 30/20; G06T 2219/2016

(57) ABSTRACT

A method of compensating for sintering warpage due to powder spreading density variations in binder jetting additive manufacturing, including receiving an initial design file defining an object geometry, representing the object geometry as a part mesh and filling the mesh with a grid of voxels to create a voxel grid, each voxel having at least one shrinkage coefficient. For each voxel, determining a distortion factor caused by a powder density variation induced during a powder spreading process and adjusting the at shrinkage coefficient of each voxel according to its respective distortion factor. Next, a shrinkage of the grid of voxels is simulated according to a sintering process. A negative compensation is applied to the voxel grid, according to the simulated shrinkage of the grid of voxels, to form a compensated voxel grid. Lastly, the change in the voxel grid is mapped to the compensated voxel grid onto the part mesh to create a pre-processed compensated part mesh.

### RELATED APPLICATION

The present application is a Continuation-in-Part of U.S. patent application Ser. No. 16/880,319, filed on May 21, 2020, and claims the benefit of U.S. Provisional Application No. 62/850,957, filed on May 21, 2019 and U.S. Provisional Application No. 62/902,189, filed on Sep. 18, 2019. The entire teachings of the above applications are incorporated herein by reference.

### FIELD OF DISCLOSURE

Various aspects of the present invention relate generally to systems and methods for distortion compensation for 3D printing.

### BACKGROUND

Mechanical processes used to print and sinter metal parts may cause multiple geometric distortions to take place upon the material. For example, parts that are 3D printed and sintered undergo shrinkage, warping, cracking, and slumping. Parts that are laser printed (e.g., using Selective Laser Melting and Direct Metal Laser Sintering) may also undergo geometric distortions. Parts that manufactured using metal injection molding (i.e. MIM) may also undergo geometric distortions.

To account for these geometric distortions, engineers may attempt to guess at dimensional corrections, and geometry additions (e.g., supports) and apply them to the manufactured parts in order to achieve a post processed result that approaches near net shape of the designed parts. As an example, an engineer may anticipate that a part will experience slumping in a sintering process and thus create a part design including a distortion in one direction, such that the 3D printed resultant part may be near the desired shape after slumping. These engineer designed approaches may use only “as-measured” data points from scans or photographs. The resulting corrections-usually negative offsets—may thus be haphazard and inaccurate, both because they are manual and because they are based on the final result, with no knowledge of the time-based process that achieves these results.

A desire exists for a way to provide mechanical designs and manufacturing solutions that result in desired geometries. The following invention is directed to systems and methods for addressing this need for designing and manufacturing parts while accounting for geometric distortions that may occur during manufacturing or post-processing.

Powder produced parts may be created via 3D printing of binders onto layers of powder material which may include metal, ceramic or wood particulate, or via injection molding of powder material into fixed rigid molds. The resulting parts contain voids among the bound particles. During sintering, these voids may collapse and the parts may shrink up to 13-17% in the case of metals such as stainless steel 17-4PH and 316 L. Shrinkage combined with friction, gravity, and non-uniform densities in the powder distribution will often cause distortion. Distortion may cause the final shapes of the parts to fall outside of the required shape tolerances.

Previously, manufacturers would linearly scale-up part shapes in order to compensate for shrinkage. This would enable a part to be scaled up before printing such that after sintering, shrinkage would bring the parts back to their original shapes. However, distortion combined with shrinkage may cause even linearly scaled up parts to fall outside their desired tolerances. The purpose of the disclosed methods combined is to provide a method for compensating for not only shrinkage/swelling transformation but also the distortion caused during this transformation.

### SUMMARY

In exemplary embodiments, a non-transitory, computer-readable medium for use on a computer system containing computer-executable programming instructions for performing a distortion simulation can perform methods for distortion compensation and/or methods for additive manufacturing and metal injection molding manufacturing.

The method can include receiving a model of a part used in at least one of additive manufacturing or metal injection molding manufacturing; generating a cell mesh using the received model of the part; and/or performing a simulation on the cell mesh undergoing one or more mechanical processes.

In at least some embodiments, the simulation can include an input parameter representing at least one of a mechanical property of the part, a coefficient associated with the one or more mechanical processes, or a combination thereof and/or generating, based on the simulation, a distorted cell mesh.

In exemplary embodiments, the method can also include receiving a scan of a physical part generated from the one or more mechanical processes; defining a set of rotation axes comprising at least a first rotation axis and a second rotation axis; defining an axis of the set of rotation axes as at least two increments; computing rotational deviation for the at least two increments; identifying, of the computed rotational deviation for the at least to increments, the lowest computed rotational deviation; identifying one or more axes of the set of rotation axes associated with the identified lowest computed rotational deviation; aligning the scan of the physical part mesh to the cell mesh based on the identified one or more axes; and computing, based on the aligned scan of the physical part mesh, a deviation score by comparing the distorted cell mesh to the scan of a physical part generated from the one or more mechanical processes.

In exemplary embodiments, the deviation score can be the average of the deviations between vertices of distorted cell mesh and nearest points on scan of physical part.

In exemplary embodiments, the method can include running a distortion simulation using input parameter values including at least one of shrinkage rate, coefficients of friction, creep strain stress threshold, and material compliance; iterating the running of the distortion simulation by incrementing values of input parameters; and/or generating the deviation score for each step corresponding to those input parameter values.

In exemplary embodiments, the method can include repeating the distortion simulation by incrementing the input parameter values; selecting the input parameter values corresponding to the minimum deviation score and identifying the corresponding input parameter values as the tuning result; and/or generating a negative offset for the model of the part from the tuning result.

In exemplary embodiments, the generating a negative offset for the model of the part from the tuning result can include performing a first distortion simulation on initial cell mesh to produce a first distorted cell mesh using parameter values from the tuning result; initializing a map of aggregate distortion vectors corresponding to vertices in initial cell mesh; computing values for first distortion vectors where each first distortion vector is the difference between the position of a first distorted cell mesh vertex and the corresponding position of the initial cell mesh vertex; updating the map of aggregate distortion vectors by applying one or more first distortion vectors; adding distortion vectors from map of aggregate distortion vectors to positions in initial cell mesh to create first updated cell mesh; performing the distortion simulation on first updated cell mesh to produce a second distorted cell mesh; computing values for second distortion vectors, wherein each second distortion vector is the difference between the position of a second distorted cell mesh vertex and the corresponding position of the initial cell mesh vertex; updating the map of aggregate distortion vectors by applying one or more second distortion vectors; and adding distortion vectors from map of aggregate distortion vectors to positions in first updated cell mesh to create second updated cell mesh.

In exemplary embodiments, the method can include repeating the steps of performing a distortion simulation on Nth updated cell mesh to produce a Nth+1 distorted cell mesh and updated map of aggregate distortion vectors; and stopping the repeating of steps when the deviation between positions of vertices in Nth+1 distorted cell mesh and positions of vertices in the initial cell mesh is within a tolerance of plus or minus (+/−) 1%.

In exemplary embodiments, the updated aggregated distortion vectors can be applied to a generated triangle mesh.

In exemplary embodiments, the triangle mesh generation can include defining a vector function on the triangle mesh based on the updated map of aggregate distortion vectors; and generating a distortion mesh based on the vector function and the updated map of aggregate distortion vectors.

Disclosed in part is a method of simulating and compensating for shrinkage and distortion caused by density variations in powder produced parts (including metal, ceramic, etc). Described in the preceding paragraphs is a method of generating a compensated shape called a “pre-process” shape of the part which causes the shrinkage and distortion operation to produce a “post process” shape part that is very close to the original shape. Also disclosed is a method of iterating the simulation and compensation steps in order to produce a pre-process shape that will transform during this process to a post-process shape that minimizes deviation from the desired shape.

Disclosed are several methods for simulating non-uniform shrinkage within part shapes as a function of position and time, particularly in powder produced parts undergoing shape transformations (e.g. sintering). These behaviors include non-uniform shrinkage rates in regions of parts due to density variations. Density variations may be caused by powder spreading, by powder bed packing gradients, and by infill regions that cause voids. Also disclosed are methods for simulating and compensating for swelling, the inverse of shrinkage, as it may pertain to parts that increase in size, for example due to a manufacturing step such as heating or curing, due to environmental influences such as the absorption of moisture, or due to other effects.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments. The patent or application file contains at least one drawing executed in color. Copies of this patent or patent application publication with color drawing(s) will be provided by the Office upon request and payment of the necessary fee.

FIG. 1 is a block diagram of an exemplary system and network for determining and correcting mechanical distortion while manufacturing parts, according to an exemplary embodiment of the present invention.

FIGS. 2A and 2B depict a test sample rod and its mechanical distortion, according to an exemplary embodiment of the present invention.

FIGS. 3A-3H depict sintering distortion simulation user interfaces, according to an exemplary embodiment of the present invention.

FIG. 4 is a flowchart of an embodiment of simulating and predicting a mechanical distortion, according to an exemplary embodiment of the present invention.

FIG. 5A is a schematic diagram of a neural network for tuning the distortion simulation, according to an exemplary embodiment of the present invention.

FIG. 5B is a flowchart of an embodiment of tuning the distortion simulation, according to an exemplary embodiment of the present invention.

FIG. 6 is a diagram and flowchart of an embodiment of generating a part correction, according to an exemplary embodiment of the present invention.

FIGS. 7A-7C depict transformation simulation user interfaces with part corrections, according to an exemplary embodiment of the present invention.

FIGS. 8 and 9 are flowcharts of methods of auto-positioning scanned compare zone meshes, according to an exemplary embodiment of the present invention.

FIG. 10 is a flowchart of a method of generating negative distortion vectors, according to an exemplary embodiment of the present invention.

FIG. 11 is a flowchart of a method of creating a negative distortion mesh from negatively distorted cell mesh positions, according to an exemplary embodiment of the present invention.

FIG. 12 depicts models, meshes, and vector fields used in creating a negative distortion mesh from negatively distorted cell mesh positions, according to an exemplary embodiment of the present invention.

FIGS. 13A-B depict parts deformed by powder density variations caused by a manufacturing process.

FIG. 14 depicts a top plan view of a powder bed with a printed part having an area of increased powder density.

FIG. 15 depicts a side plan view of a powder bed with a printed part as a powder dispersing roller spreads a new layer of powder during an additive manufacturing process.

FIGS. 16A-B depict a side plan view of a powder bed during an additive manufacturing process and an associated powder density profile.

FIG. 17 depicts a density profile resulting from an interface between clean powder and bound powder.

FIGS. 18A-B depict a side plan view of a powder bed during an additive manufacturing process of two objects and an associated powder density profile.

FIGS. 19A-B depict a side plan view of a powder bed during an additive manufacturing process of two objects and an associated powder density profile.

FIGS. 20A-B are images of a simulation showing powder density variations according to a variation in a density multiplier.

FIGS. 21A-B depict variations in density caused by variations in the employed density offset.

FIGS. 22A-B depict variations in density caused by variations in the employed density decay.

FIGS. 23A-B depict an initial simulation of shrinkage and warp and a negative offset.

FIG. 24 is an image of a part manufactured in accordance with FIGS. 23A-B.

FIGS. 25A-B depict variations in density during bi-directional printing.

FIGS. 26A-I depict an embodiment process to adjust for variations in shrinkage caused by variations in powder density.

FIG. 27 depicts a top view of an embodiment simulation of powder bed density variation caused by powder spreading.

### DETAILED DESCRIPTION

Reference will now be made in detail to the exemplary embodiments of the present invention, examples of which are illustrated in the accompanying drawings. Wherever possible, the same reference numbers will be used throughout the drawings to refer to the same or like parts.

As described above, engineers may manually account for distortions that may occur during part manufacturing and/or post-processing, but such manual adjustments may be unreliable, labor-intensive, and misguided. Accordingly, the present invention is directed to systems and methods for automatically generating mechanical part designs and manufacturing specifications/instructions that account for geometric distortions that may occur during manufacturing or post-processing.

One drawback with existing methods of pre-distorting parts to achieve better results is that they simply observe a final distortion and aim to adjust a part based on the final distortion. However, distortions may be attributable to several processes performed while manufacturing a part. The disclosed systems and methods recognize the need for an accurate simulation of the many mechanical processes involved in producing a physical form of a designed mechanical part. In particular, the disclosed systems and methods are directed to creating complex simulations that are time-dependent and non-linear, and based on multiple physical phenomenon.

In other words, if one simply observes the final distortion caused by an actual mechanical process, such as sintering, and applies a simplistic negative distortion to the original CAD part (or other model part) by the negative of the amount that it shrank and sagged, the result may be a part that distorts close to the desired shape, but does not match the desired shape. The reason is that a negatively distorted part will behave in a new way. For example, if a beam distorts to a sagged shape with sintering, and one simply distorts the beam upwards by the same amount that it sagged, the result of sintering the upward arched beam may still be a curved beam. The negatively distorted arch may not sag at all, or the arch shape may provide some stability that prevents it from distorting into a flat beam. The current embodiments recognize the need to provide an accurate simulation of the mechanical transform process, measure the delta in the results to the desired shape, and iteratively apply a negative transformation in a compounding way to the original part and subsequently negatively distorted parts. If the simulation is close but not exact, the current embodiments include an iterative approach that may repeatedly apply compounded transforms to the original shape, and thus result in a simulated result that matches actual mechanical transformation results. Further, even if an iterative approach is taken, the incremental modifications may be informed based on simulated parameters as opposed to based on trial- and error observations of outcomes. In this way, the disclosed systems and methods may provide accuracy in sintering (or performing any process on) parts, which may be critical to the usefulness of the final mechanical parts.

Referring now to the figures, FI 1 depicts a block diagram of an exemplary system 100 environment of a system and network for determining and correcting mechanical distortion while manufacturing parts, using machine learning. Specifically, system 100 may include various processors or platforms (e.g., design system 102, manufacturing system 104, sintering system 106, molding system 108, debinding system 110, camera system 112) and at least one network 114. It will be understood, however, that the specific components of system 100 may be altered, e.g., based on the type of part being produced, the type of manufacturing system and/or post-processing system being used, the location in which the manufacturing is taking place, etc Manufacturing system 104 may include an additive or 3D printing manufacturing system, including, e.g., a metal printing system. The various processors or platforms may be connected to network 114 and may communicate via network 114. Network 114 may be comprised of one or more of a wireless network (employing, for example, wireless fidelity (Wi-Fi) or satellite), a data network (e.g., a local area network (LAN), metropolitan area network (MAN), wide area network (WAN), the Internet, any packet-switched network, etc.), a private network, a public network, a cable network, etc.

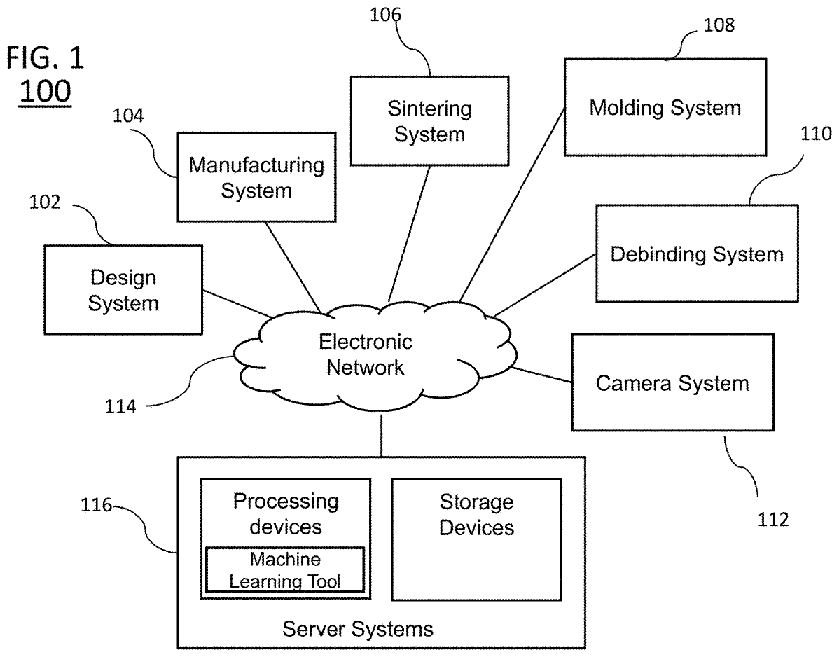

Server systems 116 may include storage devices for storing images and data received from at least one of the various processors or platforms. Server systems 116 may also include processing devices for processing images and data stored in the storage devices. Server systems 116 may further include one or more machine learning tool(s) or capabilities, e.g., due to the processing devices. Alternatively or in addition, the present invention (or portions of the system and methods of the present invention) may be performed on a local processing device (e.g., a laptop), absent an external server or network. While FIG. 1 illustrates an embodiment in which the various processors or platforms communicate with one another and server systems 116 via network 114, alternative embodiments may include the various processors or platforms connecting directly to, or being part of, at least one other processor/platform.

System 100 may comprise a software system for geometrically compensating the shape of a part and optional supporting structures in order to account for distortion due to time-based mechanical process transformations. System 100 may help achieve formation of a part that has a desired, undistorted shape. To do so, system 100 may employ a tuning phase and an application phase. The tuning phase may be applied to test or sample parts. The tuning phase may employ a neural network combined with a time-based multi-physics engine to simulate and tune simulated mechanical distortions. Once system 100 has tuned a mechanical simulation using actual sample part results (that may be digitally scanned), the application phase may be initiated. For example, system 100 may provide a means of adaptively predicting negative pre-distortions to any number of input design parts in order to correct for undesired distortions using the same mechanical process, e.g., an iterative self-adaptive part correcting mechanism. Using an adaptive iterative approach, for example, system 100 may simulate a distortion, apply a negative pre-distortion, and run the simulation again while applying a next compounded negative-distortion. In one embodiment, the iterative simulation process may be repeated until the simulated result erases all, or a threshold number of, undesired distortions caused by the mechanical process. The result of the application phase may include a design, model, or manufacturing specification(s) comprising a pre-distorted part, support structure(s), or a combination thereof, that will produce desired results when the actual mechanical processes are applied to parts manufactured according to the pre-distorted data. The output of system 100 may include a set of pre-distorted files used in downstream manufacturing.

Examples of mechanical processes that apply geometric distortions include 3D printing, sintering, metal injection molding, chemical debinding, and thermal debinding. The tuning and application phases of system 100 account for one or more of characteristics of these mechanical processes, or other mechanical processes not listed, including creep strain, phase changes of elastic to plastic deformation, friction drag, time-based shrinkage and densification, Poisson Effect of compressibility of hot materials, collisions with rigid structures, and/or responses to body forces such as gravity, surface tension, and tearing thresholds for simulating cracks. A subset of these processes may be activated in a system 100 simulation. As an example, when bound powder metal parts are sintered, they may undergo transformation distortions in the form of creep strain, shrinkage, frictional drag, and/or cracking that result in shapes that fail to match desired dimensional accuracy of parts prior to mechanical transformations. Other forms of part construction include Fused Deposition Modeling (FDM), or Fused Filament Fabrication (FFF) of MIM powders, injection molding of MIM powders. Other mechanical transformations include thermal and chemical debinding and sintering.

System 100 may comprise a software module that simulates numerous distortions that are a function of time, temperature, and other environmental factors. These simulated processes may take place, or compound, over time and are not static snapshots similar to what is obtained with simulations such as linear, elastic finite element analysis.

System 100 may further comprise one or more components for scanning/imaging (e.g., one or more of a laser scanner, camera, coordinate measuring machine, touch probe, etc.) actual samples of transformed or printed parts (made of, e.g., metal, plastic, etc.), and comparing the actual scanned/imaged samples with the simulated distorted results to obtain a number of fitness scores. A fitness score may represent the accuracy of a simulated distorted part to an actual distorted part. An example of fitness includes overall distortion of external part mesh vertices (e.g., a heat map).

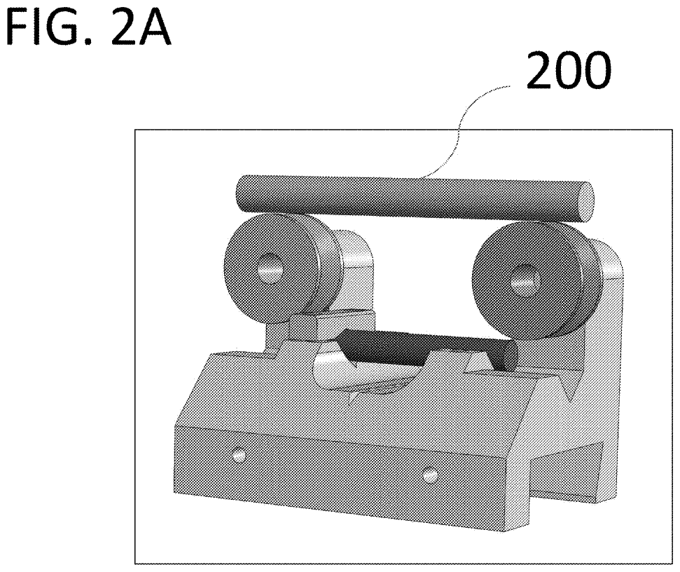

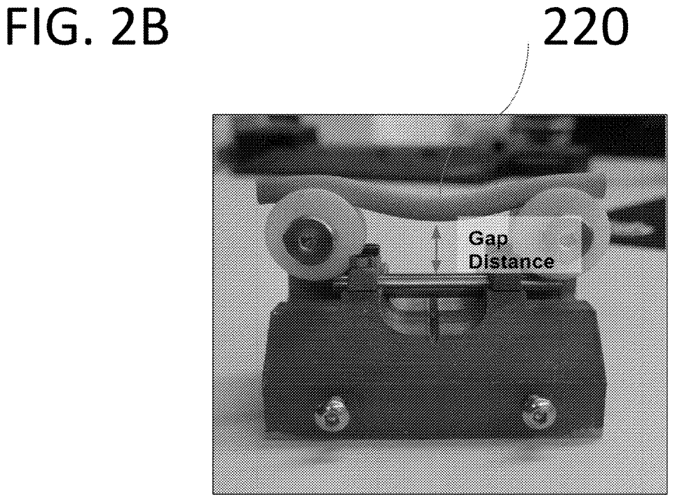

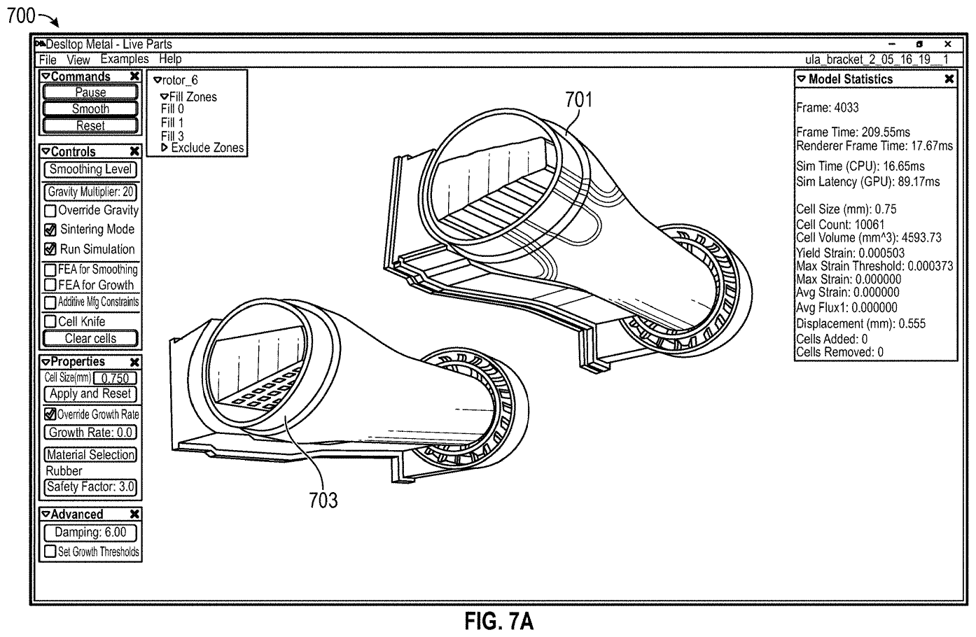

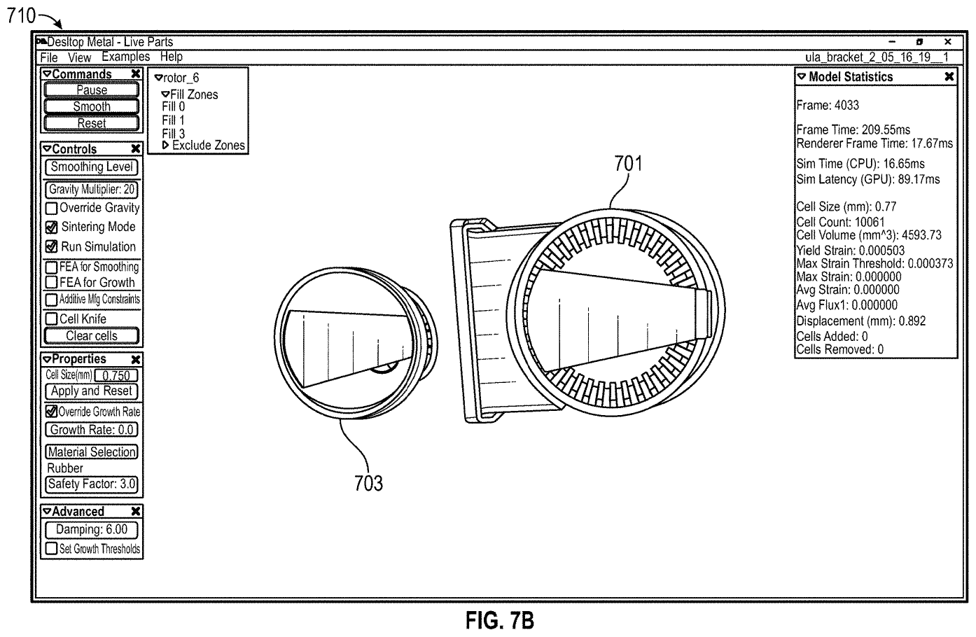

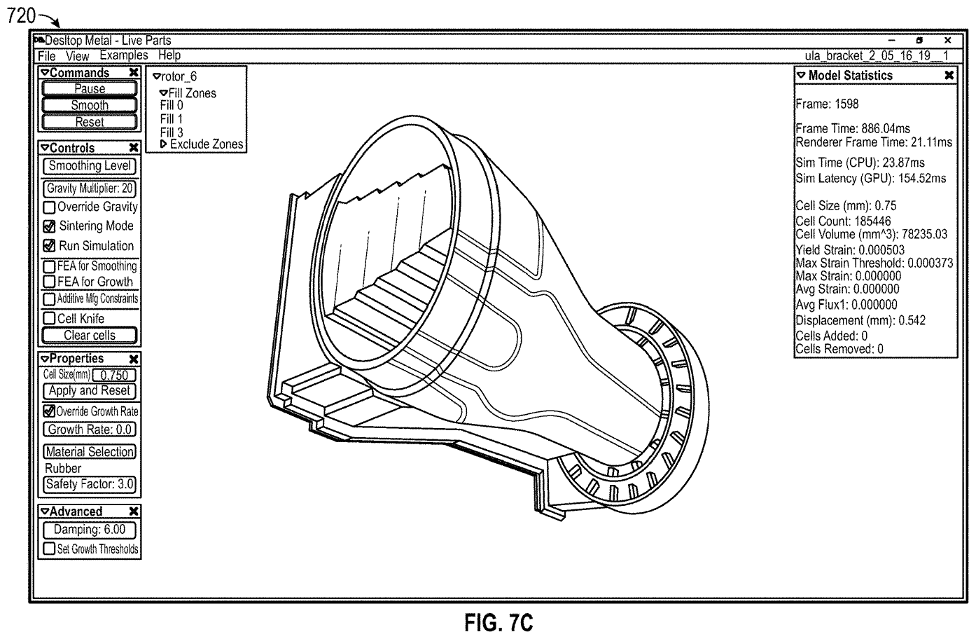

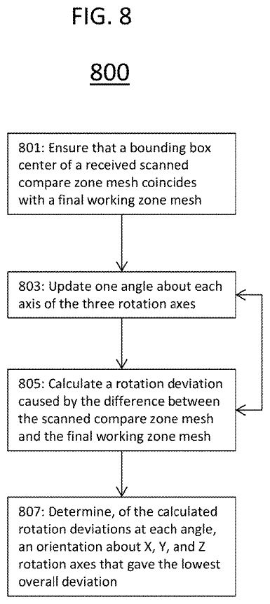

System 100 may determine and correct mechanical distortion using a variety of approaches, machine learning algorithms, simulations, and computations. The following invention describes various capabilities and functions of system 100. First, system 100 may provide a multi-physics mechanical distortion simulation, e.g., as described by FIGS. 2A-4. FIGS. 7A-7C show exemplary user interfaces and physical results of such a simulation. The multi-physics mechanical distortion simulation may provide a simulation of geometric distortions that may occur to a part, for example, during the manufacturing of a part. Such geometric distortions may occur during a printing process, sintering, post-processing, or any step taken to produce a final mechanical part. For example, one possible usage of system 100 would be to simulate mechanical transformations that take place during sintering. The multi-physics simulation may marry the combination of a time-based multi-physics simulation engine with linear elastic FEM engines (mechanical stress, heat dissipation), to accurately predict effects of mechanical processes, e.g., a part's plastic creep strain, shrinkage, friction drag, and/or elastic behavior. Simulations provided by system 100 may include CPU-based multi-physics, non-linear, or time dependent simulations, for example.

Making the manufacturing process simulation of system 100 may include an iterative training process. An initial step of an exemplary training process may include, for example, running a simulation that distorts the original mesh vertices to shrunken and deformed mesh vertices, and then checking the accuracy of the simulation by comparing the deformed mesh vertices to a scan of a physical part that was subjected to the real-life process that system 100 was set to simulate. As an example, the training process may include running a sintering simulation in which an original mesh may be subjected to one or more parameters and, as a result, may be distorted to a shrunken and deformed mesh. The shrunken mesh may represent the original mesh, post-simulation. The shrunken mesh may thus comprise a mesh of a simulated sintered part. The simulated sintered part mesh may then be compared to a scan of a physical sintered part, to check the accuracy of the sintering simulation. In other words, original mesh vertex transformations that are made to form the simulated sintered part mesh may be verified against actual transformations, provided by a scan of a physical part that has undergone sintering.

If discrepancies exist between the scan of the physical part (e.g., the sintered part) and the simulated sintered part mesh, the simulation may be adjusted, or tuned. The tuning may be performed manually, whereby a user observes the shape discrepancy between the simulation result and the scanned part, and decides to change one or more input parameters and rerun the simulation. As an example, a user may observe that the sides of part represented by the simulation result are more tipped inwards than the sides of the scanned part, and may determine that the friction coefficient of the part in the simulation against the furnace surface was too high, preventing the part from sliding inwards. Alternatively, the tuning may be performed by a neural network. The tuning may only be needed until the simulated sintered part mesh matches the scan or matches the scan within a predetermined threshold level of acceptable difference. Once the tuning has been performed, the parameter values that generate simulated part meshes that match the scan of the physical part may be identified and set for use with future simulations. In this way, negative distortions may be created for new simulated part meshes without first tuning the simulation parameters using scans of these new part meshes. The tuning process applies to materials and print/mold manufacturing processes rather than each unique part geometry. As such, one may tune the simulation parameters for a material and process using a handful of representative part geometries. Once this is complete, one may run simulations on new part geometries using these parameter values. It is possible, however, to periodically tune the simulation after the initial tuning of the simulation environment has been performed.

A neural network may be incorporated into the process used to distort a part. For example, a simulation may distort an original mesh vertex to account for geometric changes that may occur during a manufacturing process. For instance, a distortion may include an enlarged, negatively distorted version of the original mesh vertex. The enlarged version may be designated as the “working mesh”. This working mesh may be run through a sintering simulation, which should distort the enlarged working mesh to a shrunken, deformed, simulated sintered part mesh. The simulated sintered part mesh generated from the working mesh may be compared to the original (desired) part mesh. If the comparison indicates that discrepancies exist between the meshes, the working mesh may be altered to update the negative distortion applied to the working mesh, and the simulation may be run again on the updated working mesh. Comparing of the simulated sintered part mesh to the original part mesh, updating the working mesh, and running the simulation, may be repeated until the simulated sintered part mesh generated from the working mesh matches the original part mesh within a given threshold, or until there is no difference. The neural network may be used to detect and anticipate parameter changes/distortions that should be made to a working mesh, to ensure that a post-manufacturing geometry reflects the original part mesh.

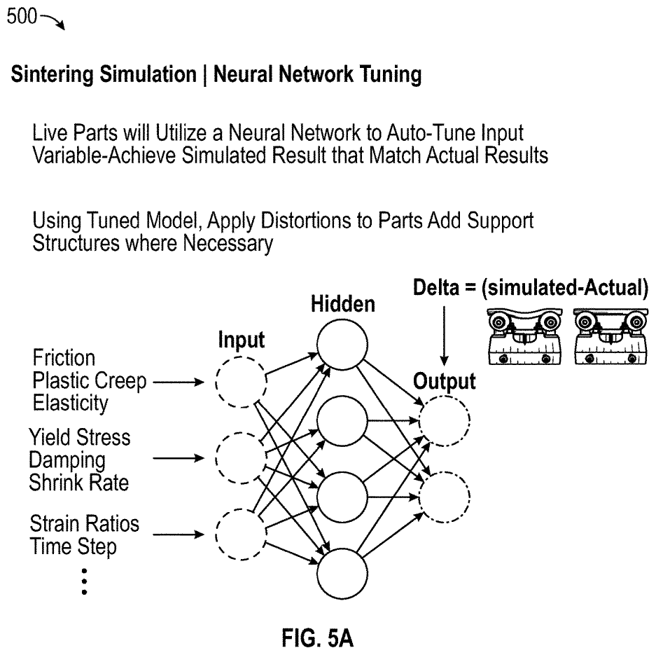

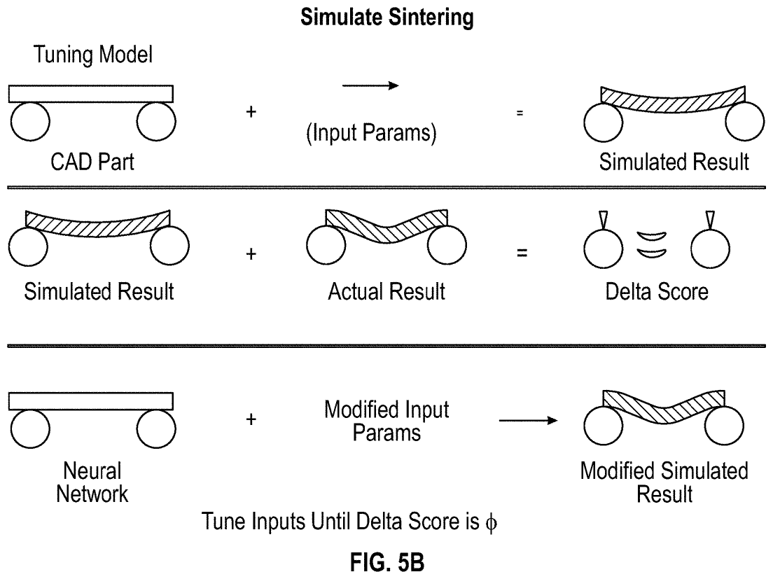

System 100 may also tune or train a simulation environment, in order to provide accurate simulations of the geometric distortions. For example, system 100 may use an approximation of many complex behaviors from predicted effects of mechanical processes to tune a simulation to obtain results that match actual test sample parts. The tuning of the simulation may involve employing a neural network, e.g., as described in FIGS. 5A and 5B. The neural network may be paired with one or more cloud-based high speed simulation cores.

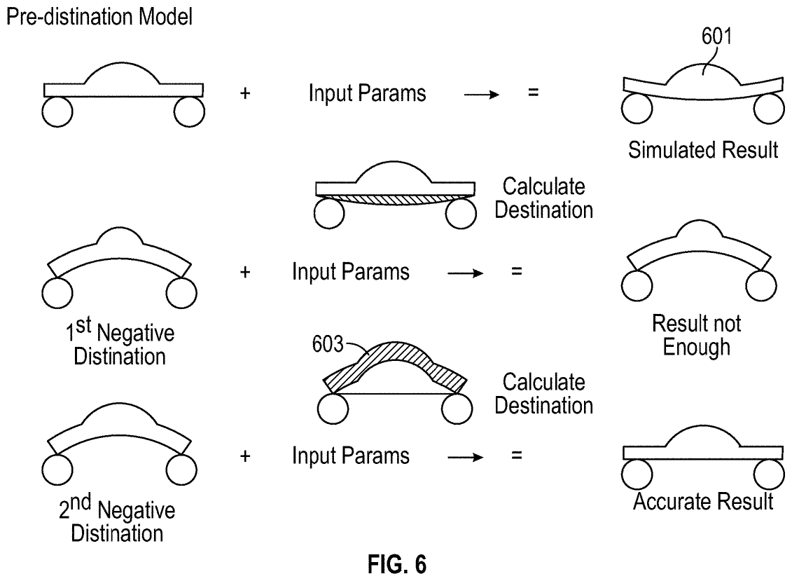

System 100 may further apply an adaptive iterative negative pre-distortion approach to generate design part shapes that will distort through simulation to give shapes that match desired design part input shapes. In other words, system 100 may tune distortion models based on actual/physical scanned parts. This approach is described in greater detail at FIGS. 6 and 7A-7C. Adaptively iterating via simulation may correct for excessive or insufficient negative distortions. In some embodiments, the goal of system 100 may be for a manufactured product to reach at least 90% of the desired net shape, or at least 95% of the desired net shape (for example, at least 97% or at least 98%). Furthermore, system 100 may use scanned/imaged 3D digital information to tune the already tuned model. The tuned simulation may be initially based on a number of sample test parts. In one embodiment, once the system 100 is being used to generate negative pre-distorted design parts, and once these parts are being manufactured, system 100 may use the manufactured parts as new data points to further tune the already tuned model. Below is a detailed description of each of these aspects of system 100.

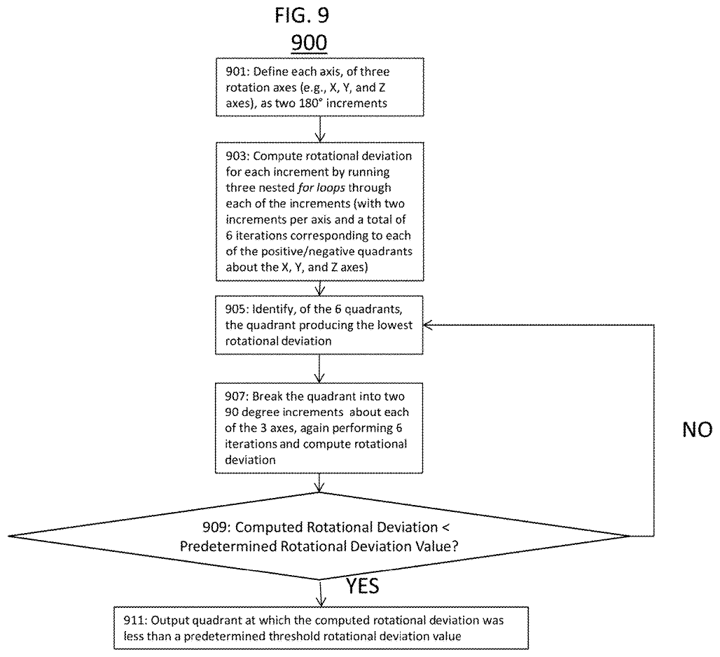

As part of checking or ensuring that the distortion corrections are correct, system 100 may use camera/scanner/measurement data acquisitions to fine-tune a tuned simulation model. Furthermore, system 100 may provide a way to compare a physical, mechanically processed part, to an original part mesh. For example, system 100 may provide an auto-positioning mechanism to facilitate this comparison (e.g., FIGS. 8 and 9). The auto-positioning may permit a way to quickly discern discrepancies between an original part mesh indicating a desired structure of the part, and a physical part that has undergone a manufacturing process.

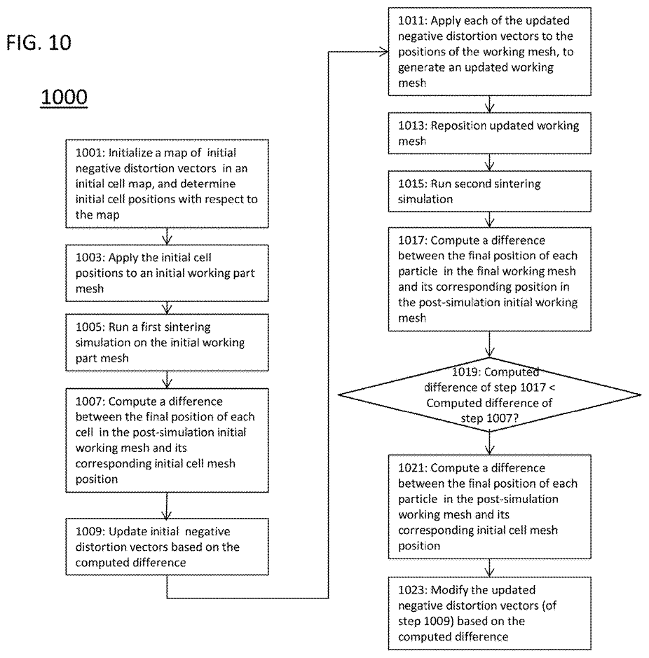

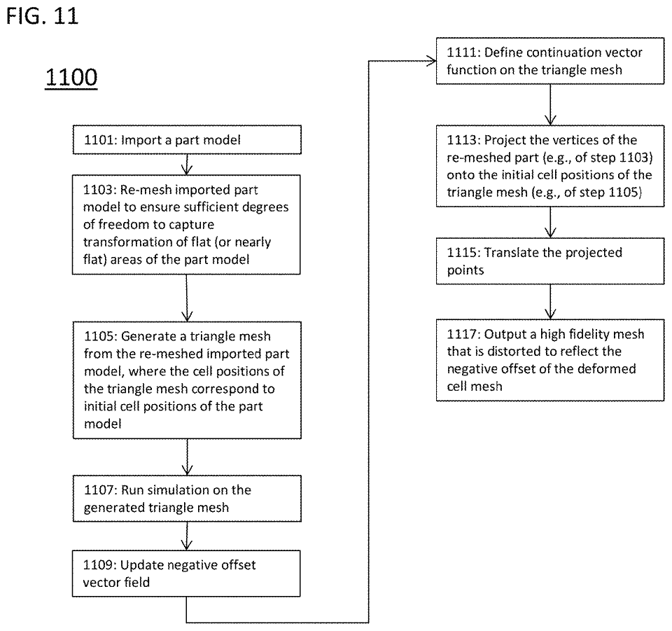

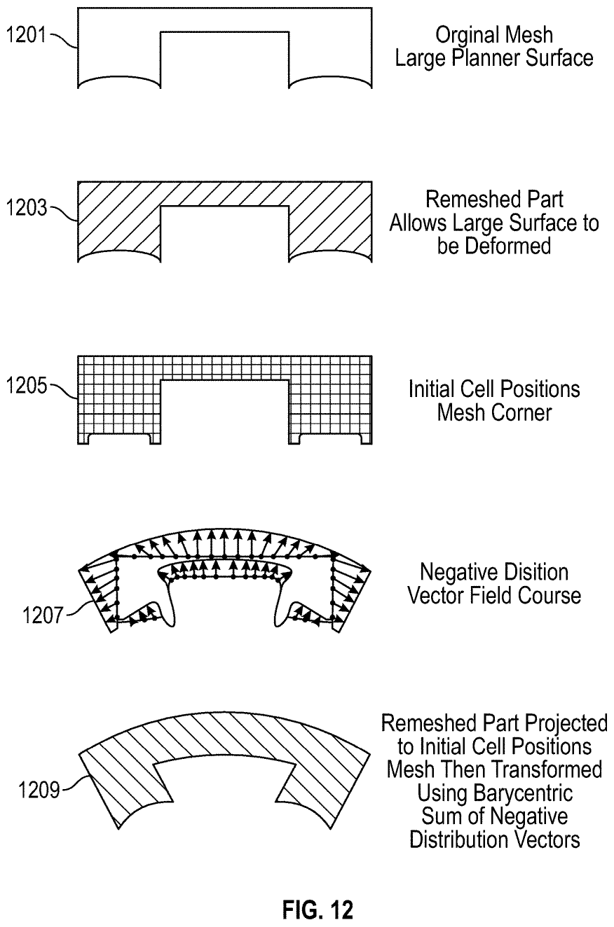

Throughout this invention, several references are made to distorting models/meshes and simulating distortions. As possible embodiments, the invention describes an exemplary method for iteratively generating negative distortion vectors (e.g. FIG. 10) and an exemplary method for creating distortion meshes (e.g., FIGS. 11 and 12).

Multi-Physics Mechanical Distortion Simulation

As previously described, system 100 may provide a mechanical distortion simulation environment. The simulation environment may use a multi-physics approach to provide a high speed time simulation of mechanical effects, such as shrinkage, creep deformation (e.g., plastic creep deformation), and friction drag. These simulations have coefficients that may be used to tune the behavior and outcome.

To illustrate. FIG. 2A depicts an exemplary CAD model 200 showing a test sample rod Although CAD models are referenced herein for ease, it is understood that any suitable model type may be used within the context of this invention. In one embodiment, the CAD model 200 of the sample rod part may be loaded into system 100, or software comprising system 100. System 100 may simulate the distortion of the test sample rod of CAD model 200 due to a mechanical distortion process involving heat, time, and other factors that the sample rod part may be subjected to during manufacturing (e.g., during sintering, printing, debinding, or other mechanical processes). For example, FIG. 2B illustrates one such real-life distortion 220 that could be simulated by CAD model 200. Such real-life distortion 220 could be a result of sintering, printing, debinding, or other mechanical process(es). In one scenario, a distortion such as distortion 220 may be scanned/imaged to create a 3D digital model of actual transformed results.

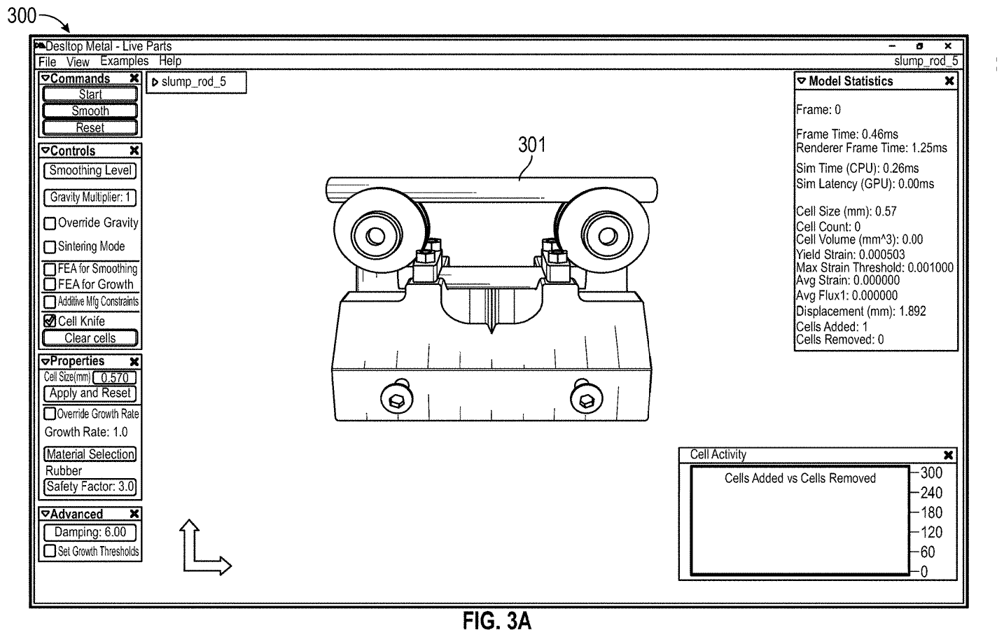

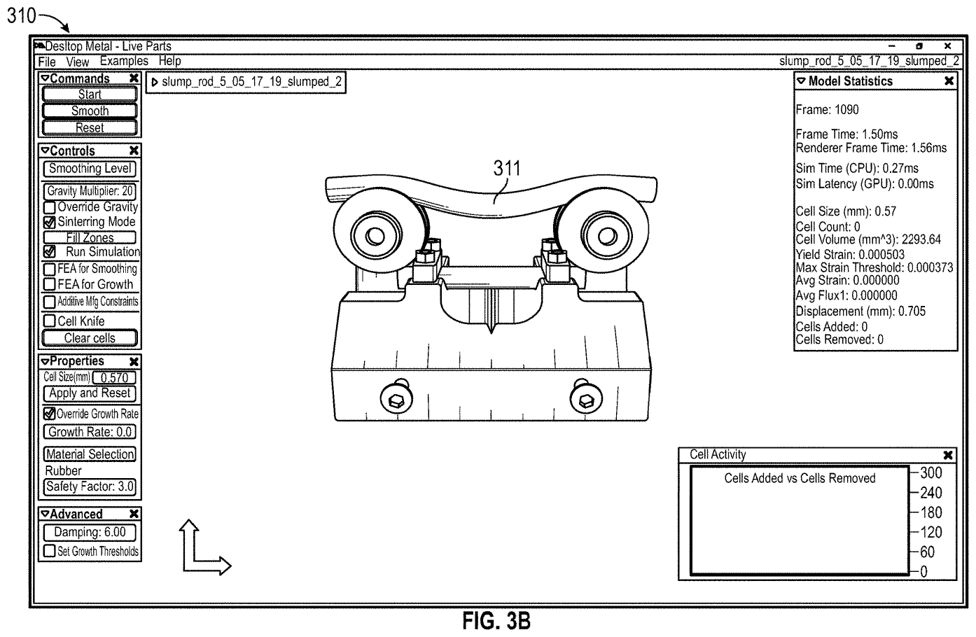

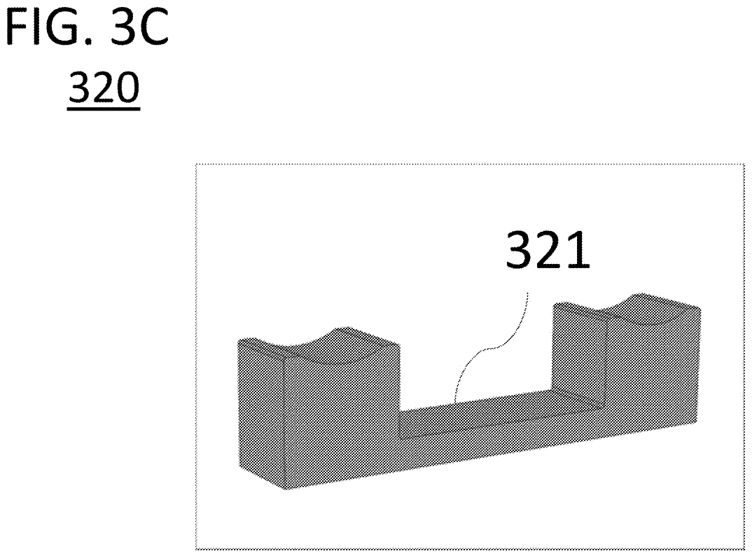

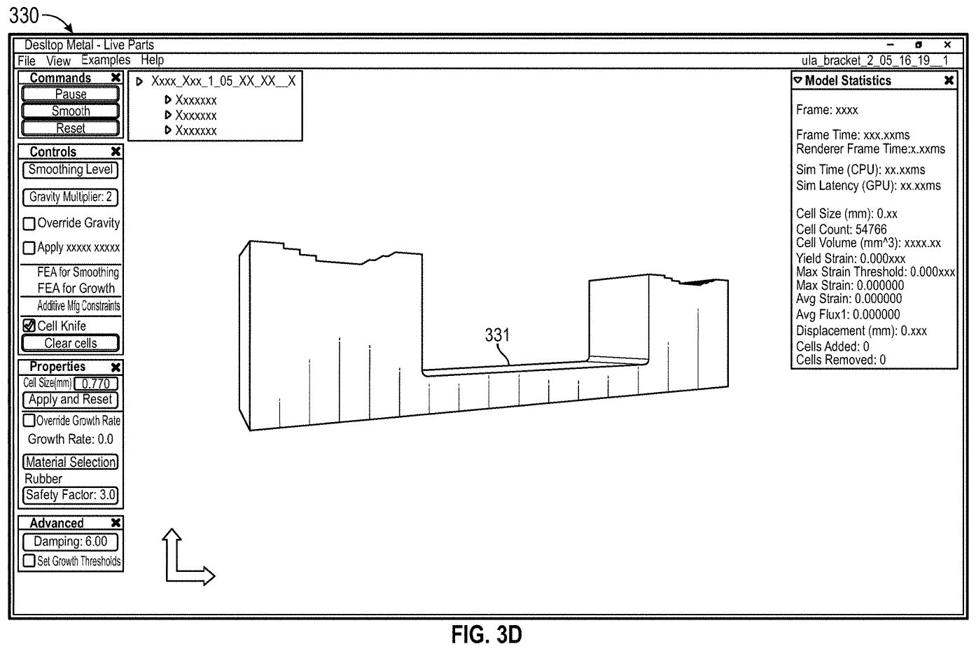

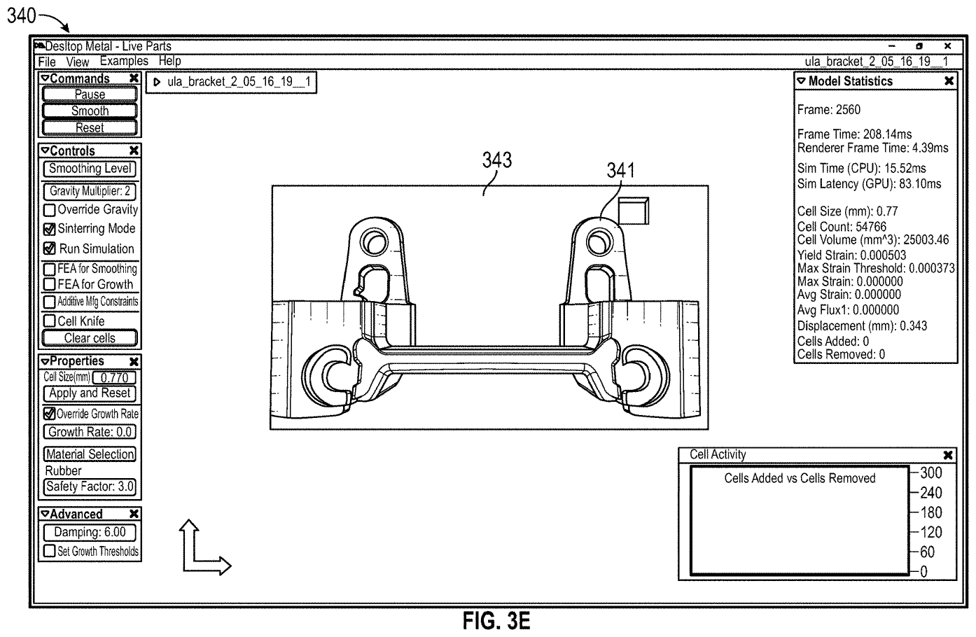

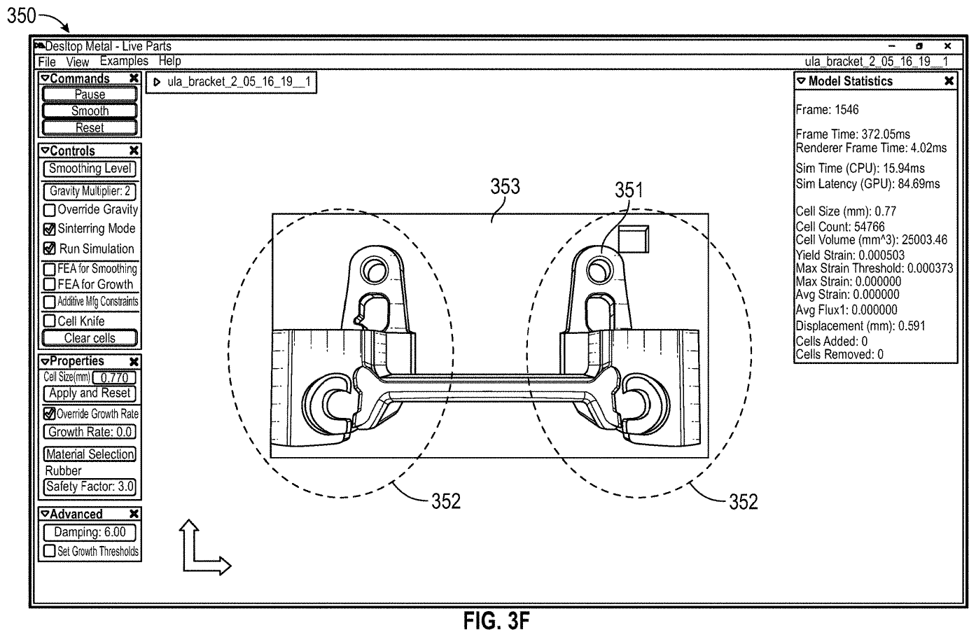

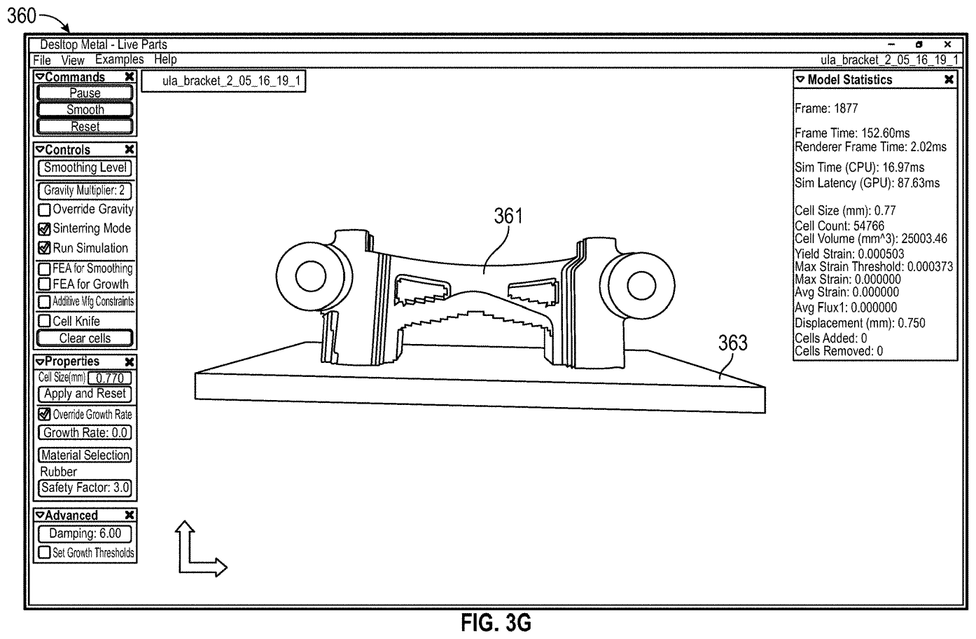

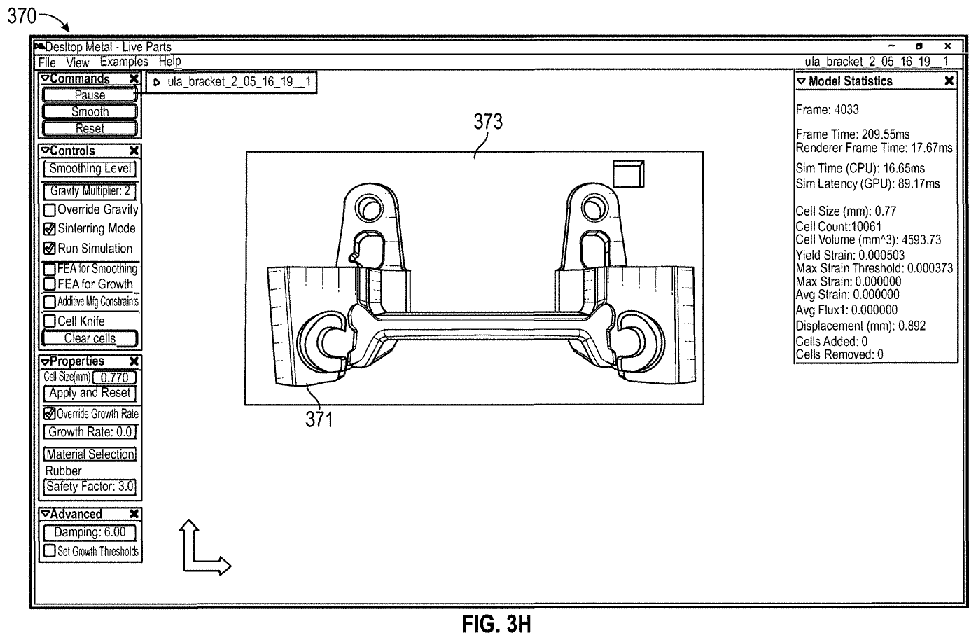

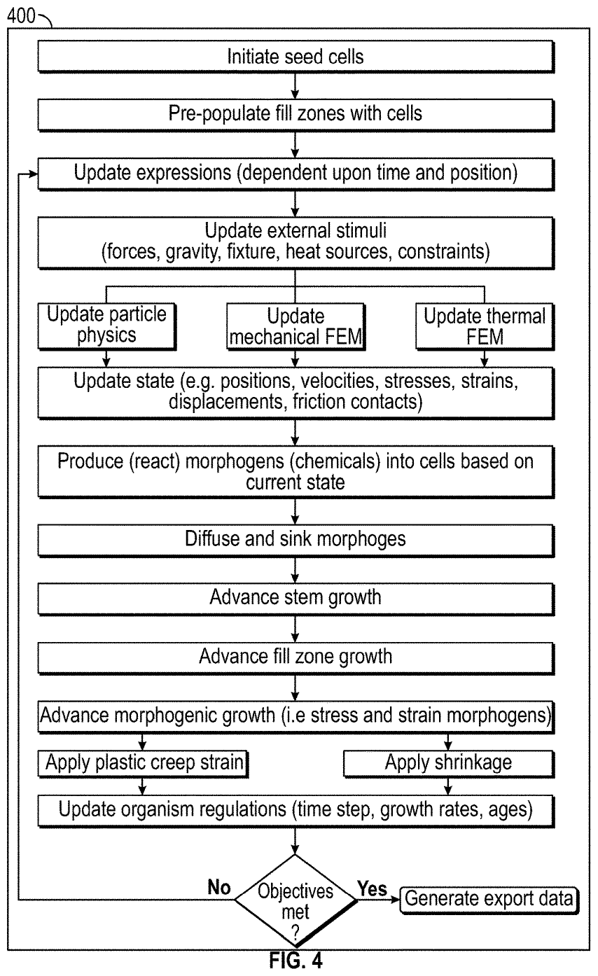

FIGS. 3A-3H depict exemplary distortion simulation user interfaces into which CAD models (or other suitable models) may be input/uploaded. For example, user interface 300 of FIG. 3A shows a CAD model 301 prior to a simulated distortion. User interface 310 of FIG. 3B shows a resultant CAD model 311 after running a time-based multi-physics simulation of slumping on the CAD model 301 of user interface 300 that subjected CAD model 301 to modeled physics parameters intended to simulate the forces that a part manufactured based on CAD model 301 would be subjected to during the manufacturing process. Such forces may occur from gravity, heat, compression, weight, etc. As shown by the Appendix, the simulation effects provided by system 100 may include the effects of compression-induced bulging, friction-induced drag and cracking, gravity or heat-induced slumping or stretching, etc. For example, system 100 may provide a high-speed simulation of varying compression based on the height of a material or part. In addition system 100 may provide a high speed simulation of creep strain even on complex geometry. Similarly, user interface 320 of FIG. 3C shows a CAD model 321 prior to a simulated distortion, and user interface 330 of FIG. 3D shows a resultant CAD model 331 after running a time-based multi-physics simulation of compression distortion on the CAD model 321 of user interface 320 that subjected CAD model 301 to modeled physics parameters intended to simulate the forces that a part manufactured based on CAD model 301 would be subjected to during the manufacturing process. Compression distortion could be caused by gravity, material composition, surface tension, attachment of the part to fixed surfaces, movement in an assembly, etc., all of which could be captured by the simulation of compression distortion shown in FIG. 3D.

FIGS. 3E-3H depict exemplary sintering transformation distortion simulation user interfaces. For example, user interface 340 of FIG. 3E includes a top view of CAD model 341 representative of a part. There may be high friction simulated between the part/CAD model 341 and the base 343 on which the part/CAD model 341 is positioned, so the part/CAD model 341 may stick as it shrinks. This may make the part/CAD model 341 deform, rather than slide along the base 343. CAD model 341 may illustrate this deformation. User interface 350 of FIG. 3F depicts a simulation environment in which friction coefficients are lower. As a result, CAD model 351 simulates the lower friction coefficients by illustrating a base 353 that breaks free and slides. The simulation may include the feet of CAD model 351 opening up to be pigeon toed, as depicted in FIG. 3F. The “pigeon toe”/opening transformation 352 may be due to shrinkage and friction. The CAD model 351 may warp from the transformation 352. FIG. 3G includes a user interface 360 depicting a back view of CAD model 351 on base 363. In particular, the back view may show a slump 361 in the opened/pigeon-toed CAD model 351. FIG. 3H shows a user interface 370 of a top view of base 373 in which one side 371 of the CAD model breaks free of base 373 and slides. Such sliding may occur once sintering has occurred for a given duration. For example, a part may increasingly “open” during a sintering process in a furnace, until the opening overcomes the friction coefficient, and a portion of the part breaks away from a base. The simulation of system 100 may model such an opening transformation, as shown by the user interfaces of FIG. 3E-3H. In one embodiment, the sliding in FIG. 3H may be shown for a simulation associated with a given time cycle. The exemplary simulations of FIGS. 3A-31H may be performed one at a time, or in any combination.

FIG. 4 shows a method 400 performed by system 100 to provide a simulation environment, according to one embodiment of the present invention. For example, system 100 may use a multi-physics engine that models the behavior of solid objects as a combination of rigid bodies, or as deformable bodies. In order to model deformable bodies, system 100 may simulate the material of a part as an idealized “fluid.” One way to achieve such a simulation is by modeling the material as a collection of spheres that collide and resist overlapping. As part of the simulation, system 100 may arrange the spheres in a cube formation, with one cube on each corner of a cell. One or more of the steps in FIG. 4 may be optional. For example, the steps involving chemicals and diffusion (e.g., produce mophogens, diffuse and sink morphogens, etc.) may contain a representation of the stress and strain that provides an average effect of stress and strain, and spreads the effect of instantaneous blips in stress and strain. However, in some embodiments, these steps may be bypassed, and the method of FIG. 4 may directly proceed from an “update state” step (e.g., updating stress and strain parameters) to the “apply plastic creep strain” or “apply shrinkage” steps.

A “cell” in the present invention refers to a parameterized, modeling building block that makes up a model of a part in order to simulate the reactions of the part to applied forces over time. For example, a cell may be comprised of a mathematical and visual representation of physical material properties, mechanical properties, electrical properties, thermal properties, chemical properties, or a combination thereof. For instance, one exemplary cell may include a representation of elastic material properties by modeling one or more physical elements, such as springs, dampers, and masses.

For example, the system 100 may attach spring/damper structures along the rectangular grid of spheres and use criss-crossing springs on the faces of each cell connecting the diagonals across the face of each cell in a model. Such a simulation method may give the deformable structure the ability to change shape without flowing out of control as is the case with a fluid. The structure may then behave as elastic, according to supplied material properties such as Young's Modulus.

The collection of attached spheres with springs and dampers may allow the system 100 to model the interaction of a deformable object as it collides and deforms elastically with other deformable objects in addition to the rigid bodies that are represented by mesh objects.

The multi-physics engine may be coupled with one or more linear elastic finite element method (FEM) modules that may take a mesh representation of the parts as represented as deformable objects, and given the forces and boundary conditions such as friction contact points at some point in the time based simulation, the software of system 100 may provide a stress measure for each point location at the center of the spheres.

Exemplary simulations provided by system 100 may include simulations of plastic creep strain and/or shrinkage. One approach for simulating creep strain deformation may be to modify the normally linear elastic behavior of the multi-physics spring/damper/collidable sphere model with a stress based spring relaxation approach that essentially relaxes the resting lengths of springs over time—from one step to the next. In taking such an approach, system 100 may take the assumption that a spring under load will stretch from its resting length. Over time, the simulated model/structure may reach an equilibrium, where the stretched spring may have a reactive force that equals the applied force. In one embodiment, system 100 may measure the stresses of the material at different snapshot points in time (rather than let the simulated structure reach an equilibrium). In such a case, the measured stresses at snapshot points my be used to modify the spring resting lengths in order to relax them and simulate plastic deformation. This approach may achieve plastic deformation simulation by combining the multi-physics elastic time-based behavior with point-in-time snapshots of stress using a linear FEM simulation.

In one embodiment, system 100 may perform this relaxation to the springs that connect spheres. System 100 may derive the stress at a cell location, along with the strain of the springs, as measured by the deformation versus their resting lengths. Using a scientifically understood relationship of the time rate of strain change or delta strain delta, time as a function of the stress, temperature, and other factors, the system 100 may measure the desired spring lengths along with the resting spring lengths, and change the resting spring lengths as a linear interpolation of the resting lengths and desired lengths—where the interpolation weighting factor may be a function of the strain on that face (edge and diagonal springs on a face) and the stress in the vicinity.

System 100 may also simulate shrinkage by modifying spring resting lengths repeatedly, based on a function of time steps and overall amount of densification that has already occurred. The latter densification may be a measure of the amount the springs have already shrunk. In addition to modifying the spring resting lengths, system 100 may modify the effective collision radii of the particles so that as the material shrinks, it may allow for closer proximity of the particles. In one embodiment, during creep strain, system 100 may maintain the particle radii and relax the springs on the cell diagonals less than the edge springs. This may give the modeled material an ability to deform, while maintaining an element of incompressibility. When the radii of the particles do not change and the diagonal springs remain rigid, the material may deform and bulge outwards—this may be one way for system 100 to simulate the Poisson effect.

Neural Network Driven Tuning Mechanism of the Simulation Environment

System 100 may tune the simulation environment by using a neural network. To ensure accurate distortion compensation, the simulation environment should accurately reflect effects of actual manufacturing processes (e.g., sintering). The following embodiments describe processes to create a simulation environment that accurately reflects outcomes of manufacturing processes. In particular, FIG. 5A is a schematic diagram of an exemplary neural network 500 for building an accurate sintering simulation environment. The inputs to the neural network may include the material constitutive properties of the part and processes, and coefficients defining the simulation processes (e.g., creep strain rates, friction drag coefficients, high temperature elastic properties, etc.). The neural network may output fitness scores. Using the neural network, the system 100 may tune the inputs in order to achieve a set of values that may produce a more accurate simulation of the mechanical processes, which may result in distortions that more closely match actual distortions. The neural network may employ many computers that run the mechanical simulation in parallel.

FIG. 5B shows a method 520 performed by system 100 to tune (e.g., refine) the simulation environment, according one embodiment of the present invention. In one embodiment, tuning the simulation of the mechanical distortion may include one or more of the following steps:

1) Receive (e.g., load) a CAD model at system 100.

2) Run a simulation using a sample test part, and a number of input parameters representing mechanical properties, coefficients of mechanical processes such as friction drag, creep rates as a function of strain and temperature System 100 may produce a simulated distorted part.

3) Receive, at system 100, a 3D digital scan file representing the actual sample test part after the actual mechanical process has been applied.

4) Compute, using system 100, a delta score or fitness score. This score may be the sum of the absolute values of the distances between the original mesh vertices to the distorted mesh vertices. While the exemplary step 4 describes a comparison of meshes, the scores may be derived from a comparison of any form of the simulated distorted part against the accrual test part.

Other approaches of determining the amount of distortion may be used that give weights to certain areas.

5) If the score is bad (e.g., higher than a specified threshold in some scenarios), then the simulation may be run again and again using different parameters. When a final score is obtained that shows accurate simulation (e.g., a score within or under a specified threshold), then the iterative simulation process may be halted.

6) Employ a neural network to detect patterns in the correlation of input parameter changes and resulting score changes.

An example of two input parameters that may be modified by the neural network are the friction drag coefficient and the creep strain rate. Friction drag may characterize how quickly or readily the part slides along the circular supports shown in FIG. 5B. The creep rate may be a measure of how fast the part sags in the center. If the drag is too high and the creep rate is too low, the part will sag down on the outside of the circular supports before it has a chance to get pulled up and over the supports into the center due to creep strain if the drag is too low and the creep strain is too high, the part may get pulled into the center over the supports and not have a chance to sag downwards on the outside of the circular supports. A neural network may change parameters independently and compare the shape of a part based on scores of the deltas between original and final shape in order to determine which combination of inputs gives the best shape. In some embodiments, the neural network may produce its own input training data by running part results made from the neural network's parameter changes, through the neural network and evaluating the scores associated with these results. In some aspects, the outputs of a neural network may be set to a deviation of zero between the original part mesh and the sintered part mesh, and the neural network may be configured to push though data on the original part mesh and the parameter settings of the simulation in reverse to obtain the inputs that might produce the original part mesh after having been subjected to the simulation parameters.

Using the multi-physics based simulation module, many behaviors may be simulated in accelerated real time including shrinkage as a function of time and temperature, creep strain as a function of stress, strain, temperature, friction drag, material elasticity, Poisson effect, etc.

Alternately or in addition to simulating the complex time-based behavior of the mechanical processes described herein, snapshots, data, or measurement(s) of the shape of a part may be obtained at multiple points during a simulation. For example, a camera in a furnace may collect data on actual deformation of a part by taking images over time. Using the time-based progression of a mechanical distortion, functions may be fit to the behavior of the part during the mechanical process. This may be difficult, given the complex 3D geometry involved in many modeling scenarios. However, the shrinkage over time may be computed or predicted, and then this single physical transform aspect could be applied to a design part.

The simulation environment may be used to predict the transformed shapes of parts undergoing one or more mechanical processes.

Iterative Self-Adaptive Part Correcting Mechanism

Once a simulation environment is set up, accurate part correction may take place. In one embodiment, system 100 may provide an iterative self-adaptive part correcting mechanism based on a tuned mechanical process. For example, system 100 may provide an adaptive pre-distortion compensation mechanism in a part design (e.g., a CAD model of a part). For instance, a simulated mechanical process (e.g., a sintering run) may be tuned for a set of material properties and mechanical environmental factors (such as temperature ramp up times). The tuning of such a process may inform geometric corrections or adjustments of a part, e.g., via a self-adaptive part correcting mechanism. An accurate time-based simulation of the mechanical process may be important to obtaining a correct net shape and effectively employing adaptive tuning of negative pre-distortions.

In one embodiment, a self-adaptive part correcting mechanism may use the tuned simulation model based on actual sample parts to generate sets of pre-distorted shapes based on a set of input shapes. These pre-distorted shapes may transform to the desired original shape when run through the tuned simulation and when processed in the actual physical simulation. This mechanism may involve system 100 providing or comprising software that predicts negative distortions that will accurately transform to the original part shape, rather than to an unusable part. The process of the self-adaptive part correcting mechanism may be iterative, employing simulations and corrections, and then applying corrections to the corrections, until the compounded effect of multiple corrections achieves post simulated results that match the original parts. Iterative self-adaptive correction of negative pre-distortions in parts may include system 100 executing one or more of the following steps:

1) Obtain or detect a pre-tuned simulation model for a mechanical distortion and a defined material and environmental factors. This may include the material elastic properties, the time-based shrinkage rate, friction drag, coefficients, time rate of temperature change, etc.

2) Load into system 100 (or receive at system 100), a new design part. Support structure(s) may also be received. The part and/or support structure(s) may be received in the form of one or more CAD models or a 3D scanned data file. The model(s) or file may comprise a triangular mesh, a geode, or other representation that provides an outer boundary shape that must be negatively pre-distorted.

3) Run a simulation to generate a distorted result.

4) Compare the distorted result to the initial shape. This step may be different from the tuning process step where the simulated distorted result was compared with the actual distorted sample or test part. Here, the comparison involves detecting how distorted the result is from the desired undistorted shape.

5) Determine a negative offset amount based on the distortion. In the exemplary diagram 600 of FIG. 6, since the part sags downwards, each vertex from the initial shape may have a position below in the simulated result. This may be a downward distortion, e.g., distortion 601. The negative distortion may derive a corresponding upwards shift (e g shift 603) for each vertex. This upward shift may be the negative of the direction vector of the downward shift, and the magnitude may be the same as the downward shift magnitude or a fraction or multiple. For example, if a point drops 4 mm and a bit to the right, the upward shift may be 3.5 mm upwards and to the left. As shown by FIG. 6, the input parameters may be applied iteratively to prompt a shift (e.g., shift 603) which may compensate for the distortion of a part (e.g., distortion 603).

6) Apply a negative distortion to the original part.

7) Using the first negative distortion, run the simulation again. Again, the simulation result may be compared with the undeformed original CAD part—not the negatively distorted part.

8) Derive a new, second distortion from the above simulation. In the example of FIG. 6, the first negative distortion may be too much, and the part may fail to slump into the correct shape —resulting in a slight positive distortion. Thus, a second negative distortion may be derived, which actually pushes the part downwards—effectively undoing some of the first distortion.

9) Run the simulation on this now compounded negatively distorted part. Measure the deviation of the result against the original shape.

10) Derive and apply a third negative distortion.

Negative distortions may be repeatedly derived and applied until the simulated shape change matches the original part. This process may be adaptive and may correct for unexpected behaviors that may emerge from changing the shape of the part (e.g., in the negative direction) and running the simulation again FIGS. 7A-7C depict exemplary distortion simulation user interfaces. For example, user interface 700 of FIG. 7A shows a CAD model 701 relative to a physical part 703. The CAD model 701 simulates the slump, creep strain, shrinkage, and frictional drag of a part, its raft, and supports. The left end of the part 703 may exhibit an egg-shaped distortion. The negative pre-distortion may be applied to the part 703, support, and/or raft during manufacture in order to obtain an adaptively negative pre-distorted part that may sinter into a true net shape. User interface 710 of FIG. 7B shows another view of CAD model 701 with a simulated slump, creep, and shrinkage, relative to physical part 703. As with user interface 700, a negative pre-distortion may be applied to the part 703, support, and/or raft during manufacture in order to obtain art adaptively negative pre-distorted part that may sinter into a true net shape. User interface 720 of FIG. 7C shows an exemplary rectangular grid-based cell model that may simulate an accelerated real time multi-physics simulation.

Camera/Scanner/Measurement Data Acquisition for Fine Tuning the Tuned Model

Alternately or in addition, at least one camera, 3D digital scanning device, and/or measurement device (e.g., camera, laser scanner, coordinate measuring machine, touch probe, etc.) may be part of system 100. Such a device may observe (e.g., scan, monitor, image, or measure) the mechanical distortion process. The results of a large number of actual processed part results may be fed into a database along CAD models of the parts, one or more pre-distorted models created by system 100, or a combination thereof. In one embodiment, system 100 may use a neural network to discover patterns in deviations of actual results from original CAD models and the negative distortion models. For example, one may find that the negative distortion model is not accurate for thick parts versus thin parts. The patterns discovered with the neural network analysis may be used to re-tune the simulation model. In other words, one or more digital scan(s)/image(s) of a produced/3D printed part may be obtained and fed back into system 100 to tune the tuned simulation environment, part correcting mechanism, pre-distorted shape(s), or any other design features and manufacturing parameters/models provided by system 100.

The described scanning/data collection may take place at each, or some, of the manufacturing station end points. For example, for scanning during a 3D printing process, a camera may be mounted overhead of a part being printed. In this position, the camera may capture a picture every N passes and use edge detection to find the perimeters of the part being printed. A 3D mesh model may be produced, based on the layer height offsets of the printing process. This 3D mesh model may reflect a structure of the part, as seen from the Z axis. Scanners may also be incorporated into debind and sintering runs. Such scanners may capture scans and/or data of the part and the supports.

In one embodiment, system 100 may be implemented as part of a computer-aided design software package or system. The software package or system may include a growth-based or generative design software using a cell-based approach. A “cell” in this context may refer to a parameterized, modeling building block that makes up a model of a part in order to simulate the reactions of the part to applied forces over time. For example, a cell may be comprised of a mathematical and visual representation of physical material properties, mechanical properties, electrical properties, thermal properties, chemical properties, or a combination thereof. For instance, one exemplary cell may include a representation of elastic material properties by modeling one or more physical elements, such as springs, dampers, and masses. The user may set up modeling constraints that may guide these cells to grow from a set of seed cells into a collection of ceils. The collection of cells may grow to form a model of a physical structure Users may benefit from this solution by being able to create naturally self-optimized designs that they could not have envisioned on their own, Example embodiments can provide design tools that blend principles of growth and adaptation with engineering. In particular, example embodiments may provide elements of cell-level growth behaviors, and may include them into a toolset of building blocks for creating structures. The cells may be programmed to generate populations of cells, as reactions to the simulated application of force. For instance, cells may be added (e.g., “grown”) or removed from a part during a simulation of applied forces. This cell-based approach is discussed in detail, for example, in U.S. Patent Application Publication No. 2019/0138673, entitled “Growth-Based Design System”, and U.S. patent application Ser. No. 16/373,349, entitled “Systems and Methods for Growth-Based Design”, both of which are hereby incorporated by reference in their entireties.

In one embodiment, system 100 may import fill zones from a design software. In one instance, system 100 may then populate the imported fill zones with cells. System 100 may represent the fill zones as plastically deformable bodies that may collide with each other and experience body forces, external forces, and rigid constraints. Alternately or in addition, system 100 may import keep out zones from a design software storage or system and render these imported keep out zones as rigid bodies.

System 100 may provide a time-based simulation where a part may begin to deform under one or more loads-initially elastically. In one embodiment, at every N frames, system 100 may pause simulation and perform stress analysis on deformable meshes of the simulated part, in their deformed states. For each stress analysis, system 100 may use the current set of friction contacts that are detected between the deformable parts and the rigid bodies around them.

The stress results may be incorporated back into the cells, where the system 100 may use the combination of stress, face strain, point in time in the simulation, and a number of input parameters to determine the incremental change in spring resting lengths due to creep strain and shrinkage.

In one embodiment, one or more application(s) of system 100 may be run with no user interface(s), and the design parts may be loaded as files with input parameters, in order to run the automated neural network simulations. The actual result scan/imaging files may also be loaded from a database so that the system 100 may compare the actual point data deviations from the simulated deviations.

Once the system 100 has derived a set of negative pre-distortion values, it may output the negatively pre-distorted shapes for production via 3D printing or other processes. This system 100 may be used to simulate any type of manufacturing process that involves material that changes shape due to heat, chemical transform, and mechanical interaction with other objects. This includes debind processes in addition to sintering.

In summary, system 100 may use a combination of multi-physics based simulation engines to predict the time dependent mechanical distortions, System 100 may tune the input parameters that define these distortion behaviors using a neural network, in order to achieve simulation accuracy on a set of test sample parts, and then apply the simulation to a set of design parts in order to obtain a set of negatively pre-distorted design parts that achieve accurate net shapes when subject to the actual mechanical distortions. System 100 may allow a user to load a part into system 100, and then system 100 may simulate the distortion over time of the part and/or its supports. System 100 may further apply a negative pre-distortion (e.g., correction) to all the part(s) and support(s), to compensate for the distortion, System 100 may include and/or execute one or more of the following elements:

1) a software-based sintering simulation of the time and temperature dependent effects of creep deformation, shrinkage, frictional drag, and cracking during numerous mechanical processes,

2) a means of reading test or sample scanned actual transformed parts (i.e. sintered parts) this may be a camera or a digital point scanner,

3) a scoring function that ranks the accuracy of the simulation model to actual results,

4) a neural network that varies the input coefficients to the simulation model in order to enable simulated results to best match actual results,

5) an iterative processing engine that uses the neural network to tune the behavior of the simulated transform to achieve a small delta in the simulated to actual results.

6) a processor that accepts a new set of “design” parts to be manufactured, for which a pre-distorted negative transform is desired that will result in transformed parts that accurately match the original parts

7) a negative pre-distortion mechanism to apply a calculated opposite distortion to the design parts and optional supports based on the delta between a simulated transform of the design part and the original design part,

8) an iteration mechanism to repeatedly simulate the mechanical distortion of the design parts, calculate the delta with respect to the original part shape, apply a negative distortion, run the simulation again, and apply a compounding negative pre-distortion until the result matches the original design part, and/or

9) an export mechanism that produces a negative pre-distorted design part shape.

To further enhance the results of system 100, system 100 may include a feedback loop involving actual processed or generated physical parts. For example, image-based data of physical parts may be obtained via a camera or scanning device, and the image-based data may further inform adjustments or calibrations to be made for accurate manufacturing of a part. A neural network may be used to analyze image-based data for the feedback loop.

Algorithm for Auto Positioning Scanned Compare Zone Meshes

In some aspects, a sintered part may be scanned or imaged to reveal discrepancies between an original design model mesh of a mechanical part, and a resultant sintered part. When a sintered part is scanned (we will use ‘scanned’ herein to refer to imaging, measuring, or scanning of any suitable modality for ease), the scan may comprise or be generated as a scanned mesh, with a coordinate system of reference. The coordinate system of reference may not readily integrate with the coordinate system used in an original CAD model mesh of the part. As such, when the scanned mesh is imported into a workstation with the model part mesh, the scanned mesh may not automatically display as an overlay of or even near the part mesh. In some cases, the display may respond to the different coordinate systems of the model mesh and the scanned mesh by showing the scanned mesh as being off of the screen displaying the design workstation, e.g., if the coordinate systems do not align with one another.

The present embodiment may automatically position a scan of a real part, e.g., a real printed, debound, or sintered part, against point cloud data of the original design model, so that deviation, if any, between the simulated model of the sintered part and the actual (scanned) resulting part may be accurately determined. For example, system 100 may provide an automated mechanism that finds the best position, or a range of optimum positions, to eliminate a translation and/or rotation deviation between a compare zone mesh (e g., a scanned mesh of a real part) and the final working mesh representing the distorted sintered part, System 100 may additionally or alternatively provide manual translation and/or rotation tools that allow a user to manually orient one or more scanned compare zone meshes and place them close to the original CAD part mesh. In some embodiments, once the user manipulates the scanned compare zone mesh and/or the CAD part mesh, system 100 may include an automated mechanism to perform a closer alignment of the two meshes for comparison. In other words, system 100 may automatically position the scanned compare zone mesh and/or the CAD part mesh relative to each other for comparison, may allow a user to manipulate the scanned compare zone mesh and/or the CAD part mesh to position them relative to one another, or may allow for both some manual manipulation and some automation of the alignment process.

The automated mechanism may comprise an algorithm performing exemplary method 800, shown at FIG. 8. Method 800 may include implementing a search algorithm that would nest three for loops, each one iterating over angles, e.g., rotational angles, about the X, Y, and/or Z axes. Before beginning the iterations, the scanned compare zone mesh may be translated (automatically or by a user) so that its bounding box center coincides with the final working zone mesh (step 801). This may remove any translation effects. Then, for each iteration step of angle about each of the axes (step 803), the rotation deviation caused by the difference between the scanned compare zone mesh and the final working positions mesh may be calculated (step 805). Steps 803 and 805 may be repeated for each angle, or a subset of angles about each of the axes. Step 807 may include determining, based on the calculated rotation deviations calculated for each iteration, the orientation about X, Y, and Z that gave the lowest overall deviation.

Alternately or in addition, the automated mechanism may comprise an algorithm performing exemplary method 900, shown at FIG. 9. Method 900 may include performing a binary search within the space of a set of rotational axes. An exemplary set of rotational axes may comprise three rotation axes, the X, Y, and Z axes. The binary approach may include breaking each of the axes associated with nested for loops (e.g., of method 800) into two 180 degree increments (step 901).

Step 903 may include running through the 3 for loops. Since each of the axes may be broken into two increments, step 903 may include 6 iterations each iteration corresponding to a quadrant of the positive/negative quadrants about the X, Y, and Z axes. Step 905 may include identifying, of the 6 quadrants, the quadrant producing the lowest rotational deviation. For example, steps 903 and 905 may include computing a rotational deviation for each of the 6 quadrants defined by the 6 axis increments. The lowest of the computed rotational deviations may be identified, and the axes or quadrant associated with the lowest computed rotational deviation may be determined. This determined quadrant may be the quadrant producing the lowest rotational deviation.

Next, this determined quadrant may be broken into two 90 degree increments about each of the 3 axes, again performing 6 iterations (step 907). This may allow determination of the orientation, of the six incremental orientations within the space of this quadrant, which produces the lowest rotational deviation. This refinement of the range values for each of the three X, Y, and Z axes may be repeated until the increment is small enough to allow the scanned compare zone mesh to have a sufficiently small rotational deviation with respect to the final working mesh positions (steps 909 and 91). For example, step 909 may include comparing the computed rotational deviation to a predetermined rotational deviation value. The predetermined rotational deviation value may represent a threshold value of deviation below which would mean acceptable value of deviation permitted between the scanned mesh and the working mesh. This predetermined rotational deviation value may be input by a user, or pre-defined by system 100. The predetermined rotational deviation value may vary, depending on the level of refinement desired for matching the scanned mesh to the working mesh. Step 909 may include determining whether a computed rotational deviation is less than (or, in some embodiments, less than or equal to) the predetermined rotational deviation value. If the computed rotational deviation is less than (or equal to) the predetermined value, then the method may proceed to step 911. If the computed rotational deviation is not less than (or equal to) the predetermined rotational deviation value, then steps 905, 907, and 909 may again be repeated Steps 905, 907, and 909 may be repeated as many times as necessary to fall within an acceptable threshold of values. Step 911 may further include aligning a scanned part mesh to an original part mesh based on the identified one or more axes or quadrant. The method may output the quadrant at which the computed rotational deviation was less than the predetermined threshold rotational deviation value.

Another embodiment of method 900 may include dividing the mesh surface into grid regions. For example, a sphere surface could be broken into 8 quadrants. A part may have dozens or hundred(s) of such quadrants and surfaces. A deviation score may be calculated for each region. A neural net or other artificial intelligence/machine learning technique may be used to analyze the output and to identify regions that have a good score, as well as regions that may have bad score in terms of how closely the resultant (scanned) physical part deviates from the original design model mesh. This technique of computing a deviation score may also be used for tuning the simulation environment and ensuring that a simulated model accurately reflects the machining process, e.g., a sintering simulation accurately reflects the effects of sintering on an object.

Algorithm for Iteratively Generating Negative Distortion Vectors

System 100 may also provide a negative distortion algorithm, which may generate negative distortion vectors. The algorithm may iteratively adjust a negative offset and re-run a generative design simulation until the simulation result matches a desired part shape. The algorithm may execute the following exemplary method 1000, shown at FIG. 10. Step 1001 may include initializing a map of negative distortion vectors, where there may be one vector for each of the particles (vertices) in an initial cell mesh. The initial value of each negative distortion vector may be the position of each of these initial cell position vertices within the initial cell mesh.

Before a generative design simulation runs, the initial cell positions may be applied to a working mesh that will undergo the simulation and leave the initial cell positions intact (step 1003). This working mesh will may deform due to simulated sintering and the working mesh may be updated after each sintering run with new positions.

A first sintering simulation may be run on the initial working part mesh (step 1005). When the sintering simulation runs, the working mesh may shrink and slump. At the end of the round of simulation, the difference between the final position of each cell, or a subset of cells, in this working mesh and the initial cell mesh positions may be calculated (step 1007). The negative of each of these vectors may be added to the negative distortion vectors in the map, given the difference between each final position and initial cell mesh position (step 1009). This may be the first update of the negative distortion vectors.

Once each of the negative distortion vectors have been updated, the updated values may be applied to the positions of the working mesh to generate an updated working mesh (step 1011). The sintered and distorted working mesh may then represent the negative offset positions. This sintered and distorted working mesh may comprise an updated working mesh. For example, the updated working mesh may be bigger and bulgier than the original cell positions, because it has been negatively distorted. The updated working mesh may be repositioned in a simulation design space, to account for the dimensions and projected changes to the updated working mesh. For example, the updated working mesh may be translated in a direction opposite a gravity force so that the mesh is above a “floor” surface in a simulation, such that when the gravity force is applied in a simulation, the new working mesh would not intersect with the floor (step 1013). The negative distortion to the initial cell mesh may push the mesh into neighboring geometry, e.g., preset surfaces or mesh/geometry of other parts.

The simulation may be run again (step 1015) on the updated working mesh. When the simulation is finished, the final/post-simulation updated working mesh positions may be compared to corresponding cell positions of the initial post-simulation working mesh (step 1017). The computed difference between the post-simulation position of each cell in the final working mesh and its corresponding cell positions of the initial post-simulation working mesh (e.g., from step 1017) should be less than the computed difference between the post-simulation position of each particle in the initial post-simulation working mesh and its corresponding initial cell position (e.g., from step 1007). In some places, the difference between the final working mesh position and the initial offset position working mesh may not have distorted enough in response to the negative offsets, while in other places it may have still distorted and shrunk too much. The goal is to generate a final working mesh that looks like the initial cell mesh.

The difference between the final working mesh and the initial cell mesh positions may be calculated (step 1021) and the difference in the negative distortion vectors may be added to the negative distortion vectors map (step 1023). In one example, the first simulation run may have distorted a point on the working mesh downwards by 5 mm below the initial cell position. The negative offset may cast the point upwards by 5 mm. On the second simulation run, the final working mesh position of this point might be 1 mm below the initial cell position. This means that the initial negative offset may not have been enough, and as such the new negative offset would be 6 mm above the original position. On the other hand, if the final working mesh position was 1 mm above the initial cell position, it would mean that the initial negative offset may have been too far. As such, the updated negative distortion vector may be 4 mm above the original position.

Once the negative distortion vectors have been updated, the negative positions may be applied to the working mesh. The working mesh may be adjusted (e.g., translated so that it lies above the floor and does not intersect with it), and the simulation is run again.

Each time the simulation runs, the negative distortion vectors may be updated. This process may be repeated until the final working mesh positions fall within an acceptable tolerance of the initial cell positions. At this point, the negative distortion vector map may be deemed complete.

System 100 may maintain and save the initial cell positions, negative distortion vectors, and working mesh such that if the user saves the model and opens it again, the simulation may be continued where it left off.

Algorithm for Creating Negative Distortion Mesh from Negatively Distorted Cell Mesh Positions

In this embodiment, the original geometry may be morphed or converted to negatively distorted geometry, using the distortion data that is derived from cells. In short, detailed part geometry may be received, mapped to a set of discrete cells, a simulation may be run and the cells distorted. The distorted cells may then be used to derive negative offset vectors that may be applied to the original geometry. This embodiment may comprise an export algorithm that consolidates and stores the negative offset vectors determined from the distorted cells. This embodiment is described in more detail below, and as exemplary method 1100 of FIG. 11.

Step 1101 may include importing a detailed part model, e.g., model 1200 of FIG. 12. The imported part model may be in the form of a CAD model comprising a mesh that contains a combination of large triangles in regions that are planar, and small triangles in areas where there are fine details such as threads and small fillets. Method 1100 may comprise creating a cell mesh from this imported part model. The cell mesh may serve as an object that may undergo simulations to experience deformation, shrinkage, and ultimately negative offsetting.

A particular challenge is, applying the distortion that exists within resulting cell mesh to the original CAD part mesh, which may have more detail in fine feature areas (e.g., fillets, holes, threads) while having less detail in large planar areas. Step 1103 may include re-meshing the imported part model such that it has enough degrees of freedom to capture the transformation of flat, or nearly flat areas into slightly curved ones, e.g., model 1203 of FIG. 12.

A new triangle mesh may be defined corresponding to the initial cell positions of the model (step 1105). An exemplary block or triangle mesh (or a mesh consisting of any suitable shape of individual cells) is shown as model 1205 of FIG. 12. This mesh may be blocky with stair steps because it represents the mesh of cells. An exemplary mesh model 1205 may have a resolution of 0.5-0.75 mm. Some of the cells may push through the envelope of the original CAD mesh, while others may lie just inside the original mesh due to the fact that this mesh is a discretized working mesh that will undergo the physical simulation of sintering and negative offsetting operations.

A sintering simulation may be run one or more times on the cell mesh (step 1107). After each simulation run or subsets of simulation runs, a negative offset vector field may be updated (step 1109). Each vector may represent the displacement of one of the cell vertices from the original cell mesh in, e.g., model 1205, to the final shape of the negatively distorted mesh. An exemplary resultant vector field 1207 may be seen FIG. 12. For each cell vertex in the original cell mesh there may be a corresponding negative offset vector.

At step 1111, a continuous displacement vector function may be defined on the triangle mesh (e.g., model 1205), which may have vertices that coincide with the initial particle positions. The function value at mesh vertices may be defined as the difference between positions before and after simulation. The function value on triangle interior points may be defined as the barycentric sum of function values at triangle vertices, as shown in model 1209 of FIG. 12. In other words, if one wanted to find the displacement of a vertex on remeshed part 1203 that was part way between two vertices on the initial cell position mesh 1205, the first step would be to project this vertex to the nearest vertex on the initial cell positions mesh, and then find the negative offset vectors of the neighboring vertices. The resulting transformation may comprise a weighted sum of the negative offset vectors of the neighboring vertices.

As step 1113, the vertices of the remeshed part (e.g., of step 1103) may be projected onto the initial cell positions triangle mesh (e.g., of step 1105). For example, each vertex on the remeshed part may be projected onto the initial cell positions mesh, to find the neighborhood of nearest vertices on the initial cell positions mesh. This set of nearest neighbors may be used to look up the negative distortion vector for each vertex (or one or more vertices). In particular, the barycentric sum of these vectors may be used. This usage of the vectors may take into account the distance of each neighboring vertex, in order to establish the correct weighting for each vector For example, a nearby neighbor that is very close may have a higher weight applied to its negative offset vector than a nearby neighbor that is farther away. Once the combined or weighted negative offset is determined, this negative offset vector may be applied to the remeshed part position for each vertex. The effect of this operation is that each vertex (or one or more vertices) on the remeshed part may be negatively offset by the proper weighted amount corresponding to the nearby negative offset vertices. This projection may push the high fidelity triangles from the remeshed part onto the coarser initial cell positions mesh.

The projected points from step 1113 may be translated (as step 1115) by a displacement vector that is evaluated at the projected point, using the function defined in step 1111. The result may be a high fidelity mesh that is distorted to reflect the negative offset of the deformed cell mesh. Step 1117 may include outputting this high fidelity mesh.

The systems, devices, and methods disclosed herein may also be used to inform the generation of manufacturing support structures for parts. For example, parts made with distortion corrections may require additional supports, fewer supports, or no supports System 100 may provide automatic determinations regarding suggested support structures for making parts containing distortion corrections. In some aspects, system 100 may generate distortion corrections that may reduce or replace the need for supports (or smaller supports). For example, instead of requiring the presence of a support to uphold an overhanging bridge portion of a part, a distortion correction may be applied that forms the bridge portion in an arch shape so that the final bridge portion has a straight, horizontal profile, even without the presence of a support underneath. It is also possible that the need for supports may be reduced, e.g., fewer supports are needed, or those that are needed are less critical or smaller in scale.

System 100 may further provide automatic recommendations for manufacturing, in light of the distortion corrections. For instance, system 100 may provide recommendations as to printing orientation, sintering temperature or timing, part material distribution, etc., based on the distortion corrections' The many capabilities of system 100 may be used in any combination to enhance reliability in producing physical parts that match an intended geometric structure of the part, as exemplary only.

Powder produced parts may be created via 3D printing of binders onto layers of powder material which may include metal, ceramic or wood particulate, or via injection molding of powder material into fixed rigid molds. The resulting parts contain voids among the bound particles. During sintering, these voids may collapse and the parts may shrink up to 13-17% in the case of metals such as stainless steel 17-4PH and 316 L. Shrinkage combined with friction, gravity, and non-uniform densities in the powder distribution will often cause distortion. Distortion causes the final shapes of the parts to fall outside of the required shape tolerances. Previously, people would linearly scale-up part shapes in order to compensate for shrinkage. This would enable a part to be scaled up before printing such that after sintering, shrinkage would bring the parts back to their original shapes. However, distortion combined with shrinkage may cause even linearly scaled up parts to fall outside their desired tolerances. The purpose of the above described methods and below described methods combined is to provide a method for compensating for not only shrinkage/swelling transformation but also the distortion caused during this transformation.

Method of Simulating Shape Transformations

Shrinkage is a type of shape transformation often caused by density variations. In powder produced parts, varying sized voids among powder particles will cause density variations. As these parts undergo heat induced transformations such as sintering, these voids may collapse and the parts may shrink. Thus, shrinkage is a result of less-than-maximum density, and varying shrinkage may be caused by varying densities in different regions of a part in its powder form. Typically, when parts shrink due to partial density, the final result is a nearly 100% dense part. Thus, regions that start out at lower densities will end up shrinking more, and thus reflect higher shrink rates in these areas.

In a system that models shrinkage over time explicitly, there are multiple simulation processes that may affect the shrinkage rates non-uniformly, meaning that shrink rates may vary by position within the part, and they may vary over time. The larger part of the present disclosure focuses on modeling the shrinkage at each time step as a function of the point in time and the position within the part. Furthermore, at a particular position within a part, shrinkage rates may be a function of other parameter values that are a function of the position. For example, at a particular location, the temperature may be higher than at a different location, and temperature may functionally affect the shrink rate.

The following method may be used to model shrinkage. A powdered material may be represented as a collection of particles arranged into a voxel-like cubic packed grid. These particles may represent cell-like discrete regions on the order of 0.1 to over 1 mm, as opposed to representing micron-sized powder particles. Particles may then be attached to their immediate neighbors using spring-like position constraints along face edges, face diagonals, as well as internal diagonals. To simulate shrinkage over a time step, particle radii may be reduced, and position constraint rest lengths may be reduced. Then, during the solve step, particles may be allowed to move as a function of the collective forces applied by all position constraints exerting forces on the particles, combined with the collision effects of particles bumping into each other, as well as other objects.

Other factors of shrinkage may vary as well over successive time steps, such as the stiffness of a spring-like position constraint, or the number of particles and constraints in a certain region—i.e. representing the density of particles and constraints.

Physical Causes of Varying Shrink Rates

Disclosed below are methods for simulating shrinkages caused by the following 3D printing process behaviors during the creation of powder produced parts.

Powder Spreading

Powder spreading devices, such as rollers, blades, brushes and the like, may impart higher densities in certain regions such as the leading edge outer faces of parts that face the powder spreading rollers. Higher densities will be reflected in lower shrinkage and lower shrink rates during post-processing sintering.

Powder Packing

Print beds in binder jet systems may have gradients in powder densities due to inconsistencies in powder packing. These densities will typically fade in one of the primary axis directions within the bed—as in decreasing or increasing in—X (right to left). These gradients may also form wave shapes that are curved. A non-linear gradient may be described by a matrix of sample values measured from a sample print.

Infill Patterns

Parts with infill may have less dense regions due to gaps formed by patterns such as hex channels. Less dense regions have less mass, which will cause reduced deflection of unsupported surfaces, and lower friction interaction in areas of part contact with surfaces that do not shrink.

Shrinkage Variations Produced by Powder Spreading

During the printing process, binder jet powder spreading devices make passes over previously printed layers. Previously printed layers may contain regions of compacted powder, along with regions containing a mixture of powder and binder. As the powder spreading rollers move across these regions, small variations in the compacted density of the current layer may arise. One may observe spikes in density along the leading edges of profiles defining the boundaries between unprinted and printed regions. These spikes in powder density will remain elevated and then decay back to normal over an observed distance downstream along the powder spreading path. If parts have thin walls, the variations in density from the “upstream” sides of the walls to the “downstream” sides of the walls may become significant enough to cause distortion during sintering.

Characteristics of Distortion Due to Powder Spreading

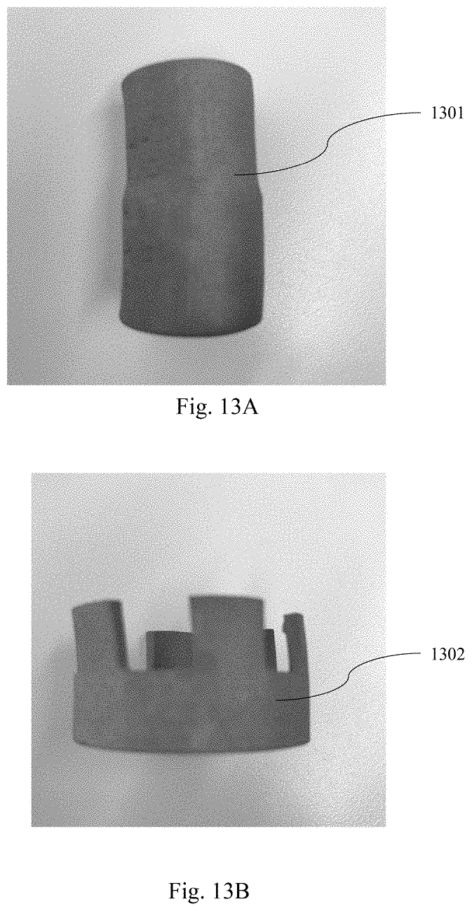

With reference now to FIGS. 13A-B, FIG. 13A depicts a socket wrench component 1301, while FIG. 13B depicts a fuel swirler 1302. Both thin-walled parts were printed as follows:
Parts were printed straight using a binder jet 3D printing process, using the SHOP SYSTEM™ by Desktop Metal, Inc. of Burlington Mass.
Parts were printed with their cylinder axes aligned vertically.
Powder spreading for each layer was from right to left.
The powder spreading roller made contact with the right-side facing walls of the parts first, causing a shell of higher density material to be deposited on the right facing walls. During sintering, the walls warp to the left, as the left-hand sides of the walls shrank more than the right hand sides. This warping behavior was observed in configurations with different wall thicknesses and wall spacings.

While the warping behavior was observed in actual parts, the disclosed embodiments do not depend upon directly measured density variations in printed parts prior to sintering. Instead, the disclosed methodology theorizes that the warpage is caused by density variations in the deposited powder. The disclosed methodology defines a formula for deriving the powder density at different locations within each layer. The derived densities are then associated with shrink rate modifiers that locally affect the shrinkage and warpage over the sintering simulation.

Density Variation Model

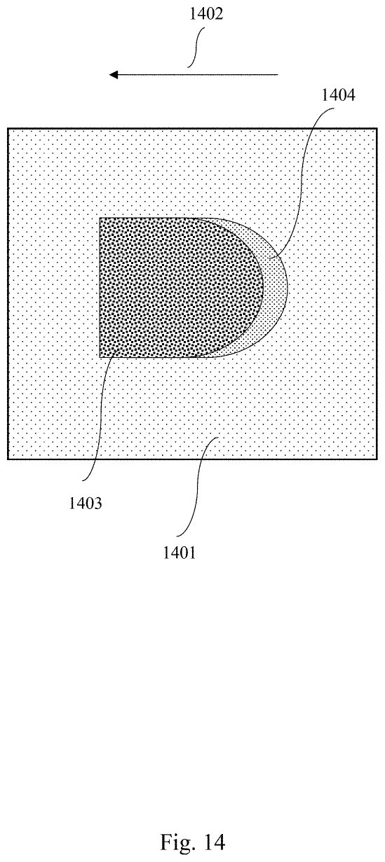

The theoretical density variation model posits a pattern of spiking the density upwards at the boundary of non-printed regions that transition into printed regions. When the boundary normal is parallel to the motion of the powder spreading roller, the density spike is stronger than when part boundary normal becomes perpendicular (i.e. when the part surfaces are tangent to the roller motion). Thus, the rightmost region of a cylinder profile will experience the largest spike in density (assuming right to left roller spreading of powder), whereas the side regions whose surface normals are perpendicular to the spreader motion will experience smaller spikes in density. The spike is therefore a function of the incidence angle of the surface at every point along each leading edge profile. FIG. 14 illustrates in a top plan view a powder bed 1401 wherein a roller (not pictured) traverses in direction 1402. A part profile 1403 is shown as formed in a prior layer of powder. The right side of the printed region is circular. The region 1404 is an area of heightened density due to the interaction of the powder spreading roller with the boundary of the printed and bound material versus the loose packed powder.

The elevated spike in density persists over a distance before decaying back to the density prior to the spike. If walls lie immediately downstream of other walls, they may end up being in the shadow, and will not experience a second density spike. The further a downstream wall is from an upstream wall, the density spike in the downstream wall will strengthen. At some distance downstream from an upstream wall, the density spike in the downstream wall will be the same as if there had been no upstream wall. In other words, at some distance downstream from a wall, the powder spreading mechanism returns to its initial behavior.

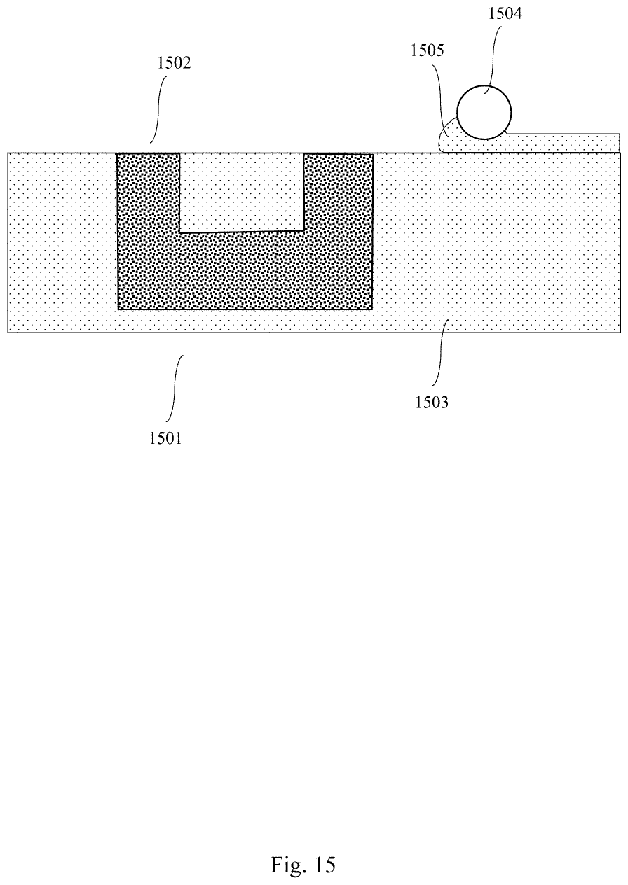

FIG. 15 shows a side view cutaway of a powder bed 1501 containing a partially printed part 1502 surrounded by loose packed powder 1503. A powder spreading roller 1504 is depicted traversing right to left. The powder spreading roller 1504 pushes a pile of powder 1505 ahead of it (in certain circumstances, a powder dispensing apparatus may traverse ahead of the powder spreading roller and deposit additional powder). Some of the powder passes beneath the powder spreading roller 1504 and becomes packed as the next layer, ready for the application of binder in the regions where parts exist.

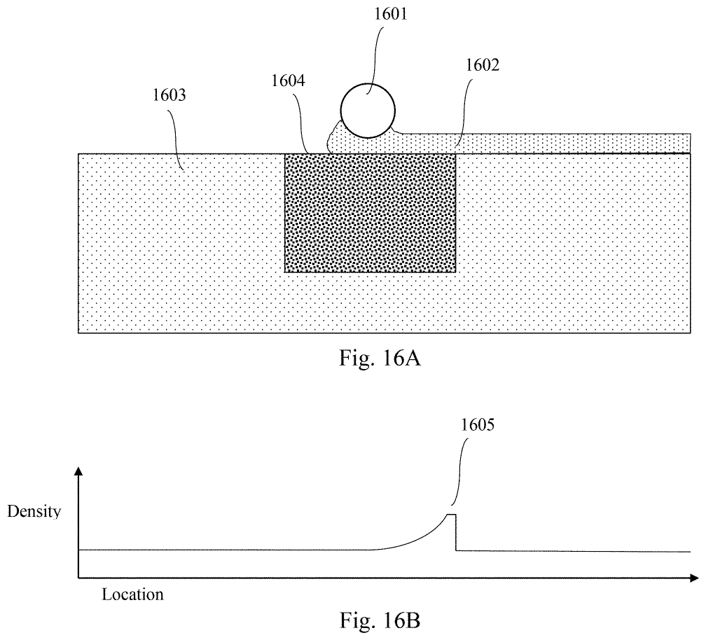

FIG. 16 depicts the powder spreading roller 1601 after it has passed over the leading edge boundary 1602 between a non-printed region 1603 and a printed region 1604. Applicant's theory is that when the powder spreading roller 1601 encounters the transition from a non-printed region 1603 to the printed region 1604, it is analogous to a street sweeper encountering a raised manhole cover. Without being bound by theory, it may be the prior layer regions that contain binder are physically raised above the non-printed regions, in the same way as a manhole cover is raised. It is possible that a slightly higher printed region would cause the powder to suddenly compact more as the roller transitioned from the lower region of unbound powder to the higher region of previously bound powder. Alternatively, and without being bound by theory, the friction and resistance in the region of the printed bound powder could cause powder to slide more slowly and cause a sudden build up, resulting in an increase in density as the roller compacts the powder. Alternatively, and without being bound by theory, the stiffness of the powder beneath the spreading roller may increase in the region of the printed bound powder compared to the region of unbound powder, resulting in an increase in pressure and therefore in density as the roller compacts the powder above the region of printed bound powder. Once the powder spreading roller 1601 has passed by the boundary, the density appears to drop quickly back to normal. The density spike appears to occur over a region of about 2-3 mm.

FIG. 16B depicts a theoretical profile of the density as a function of position in the direction of the powder spreading roller motion 1601. One can see the theoretical density spike 1605 within the deposited powder as the roller encounters the prior layer printed region. Where the powder density roller 1601 transitions from loose powder to a region of bound powder in a prior layer, density spikes.

Density Warp Model

Using the theory that the density spikes at the boundaries of non-printed to printed regions, a mathematical model that derives a relative density increase for any region in a part that is a function of the distance from the region to the “upstream” leading edge face where powder transitions from unprinted to printed. The increase in density is then mapped to a decrease in shrinkage. If the density increases in a certain region, it means that the shrinkage in that region will decrease because there are fewer and smaller voids among particles.

The model not only takes into consideration the distance from a region to the next upstream boundary surface, but also evaluates whether or not there are additional printed regions upstream of this boundary. If a boundary region has a printed region upstream of it, this may shield the boundary region from a spike of its own, as the prior spike in density may not yet have returned to normal. Thus, the presence of an additional upstream printed region, as well as its distance is considered. Finally, the incidence angle of the boundary region is considered as boundaries that are perpendicular to the direction of powder spreading cause a higher density spike than boundaries that have an incidence angle or which are completely tangent to the powder spreading direction.

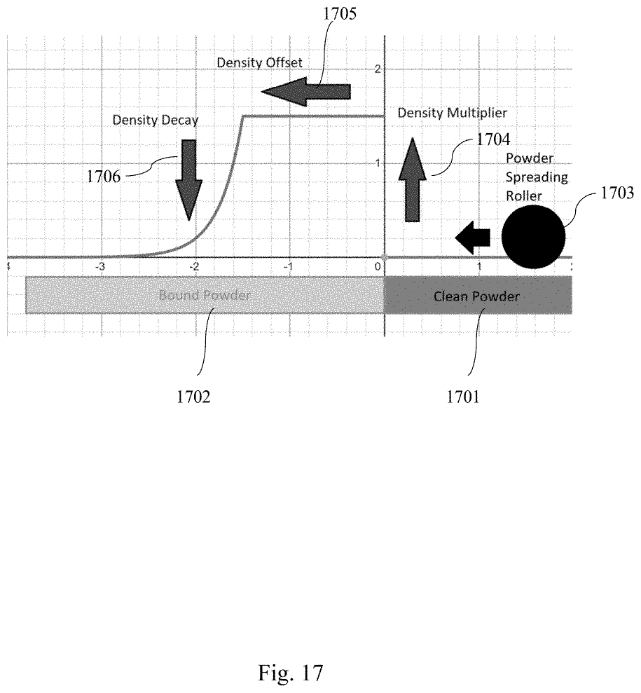

FIG. 17 is a schematic diagram illustrating the theoretical pattern of density variations in a layer where the previous layer has a boundary (x=0) between an unprinted region (x>0) transitioning into a printed region (x<0). The unprinted region 1701 contains clean powder, whereas the printed region 1702 contains powder mixed with binder. As the powder spreading roller 1703 deposits new powder and advances towards the leading edge of the boundary, the density spikes by an amount related to a parameter called a Density Multiplier 1704. The density then remains elevated over a distance related to a parameter called a Density Offset 1705. Finally, the density decays back to its original state over a distance related to a parameter called a Density Decay 1706.

A formula representing the density spike as a function of geometric parameters is:

$${D}_{F} = B \cdot {D}^{( E \cdot \frac{( F - O )}{C} )}$$

where:
B represents the Density Multiplier, which is the maximum spike in the density at the leading edges of transition from non-printed to printed regions.
O corresponds to the Density Offset. This is the distance over which the density spike remains fixed at its initial value before starting to decay. This can be seen as the flat spot on the density variation profile in FIG. 17.
D represents the Density Decay. Larger values cause the density to decay over a longer distance.
E corresponds to the Incidence Angle of points along the transition boundary. In regions where the leading edge of the part is perpendicular to the powder spread direction, this value approaches 1.0.
F corresponds to the distance of points downstream from their upstream transition boundaries. The density spike of an arbitrary voxel region in the part can be determined by measuring its distance downstream from the transition boundary. The further downstream, the more the density will have decayed from the initial maximum spike value to the normal spreading density.
C is a constant value.

Two other parameters also control density warp behavior:
Density Gap Threshold is the distance from an upstream boundary to a further upstream (i.e., prior) printed region which could cause total shadowing of the density spike in question. This is the threshold value, meaning that if an actual distance is less than this threshold the density spike will be completely shadowed or nullified by the upstream region.
Density Height is the distance from the print floor when density warping begins taking effect.

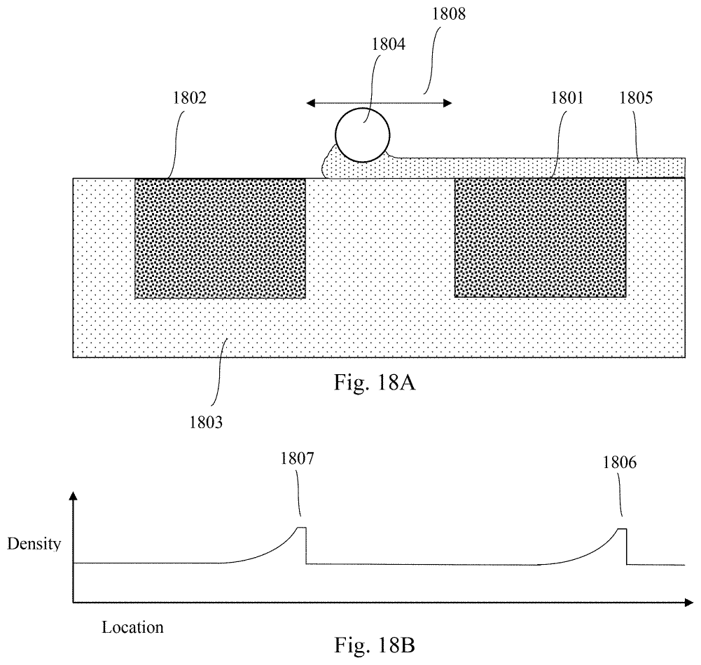

FIG. 18A shows a side plan view of a powder bed during binder printing in which there is a first object 1801 and a second object 1802 surrounded by unbound powder 1803. A powder spreading roller 1804 traverses the powder bed and spreads a new layer of powder 1805.

FIG. 18B shows the corresponding density profile of the new layer of powder 1805 (after the entire layer is spread). As visible in FIG. 18B, there is a distinct first powder density spike 1806 and a second powder density spike 1807. The first object 1801 and the second object 1802 are separated by a distance 1808 that is sufficiently large such that the first object 1801 does affect the density of the second object 1802 and the second powder density spike 1807 occurs (i.e., the leading right side edge of the second object is beyond the density gap threshold).

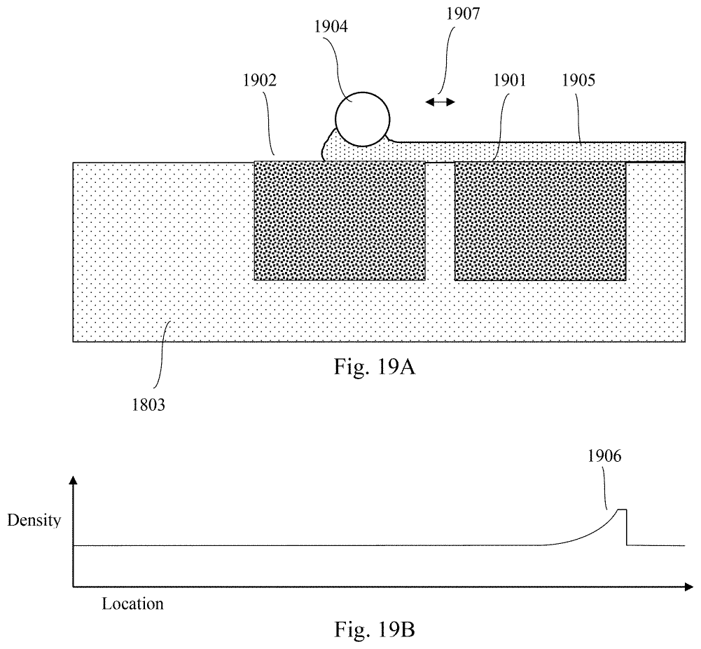

FIG. 19A shows a side plan view of a powder bed during binder printing in which there is a first object 1901 and a second object 1902 surrounded by unbound powder 1903. A powder spreading roller 1904 traverses the powder bed and spreads a new layer of powder 1905.

FIG. 19B shows the corresponding density profile of the new layer of powder 1905 (after the entire layer is spread). As visible in FIG. 19B, there is a powder density spike 1906. However, because the first object 1901 and the second object 1902 are separated by a distance 1907 that is within the density gap threshold the first object 1901 causes the second object 1902 not to experience a powder density spike. It should be understood that the first object 1901 and second object 1902 may be two portions of a single object.

Prior to running a simulation of sintering shrinkage, the density spike values at each voxel region of the part are computed using the as-printed geometry. This geometry comprises the scaled up part, and includes any negative offset compensation. Each voxel region is assigned X, Y, and Z shrinkage values that vary at each frame step of the dynamic simulation. To account for the effect of density spikes due to powder spreading, a density spike value computed for each voxel using the aforementioned approach. This density spike value is then used to derive a compensated_shrinkage as follows: compensated_shrinkage=shrinkage+density_spike_value.

To aid in understanding how this works, suppose the density_spike_value for a voxel is 0.00015 and that the shrinkage for that frame is 0.99945. When this is added to the shrinkage, the shrinkage number will become larger (i.e. 0.9996) which corresponds to less shrinkage. The density spike value may be scaled so that the compensated shrinkage may be tuned to match actual results.

Parameter Value Examples

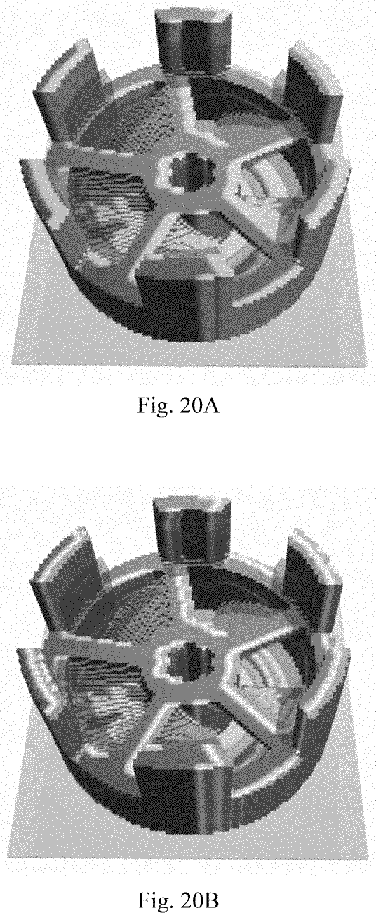

Following are images showing the simulated effects of varying the parameters that contribute to the density spikes in different regions of a sample part. The powder spreading roller in this case was moving from right to left. The baseline density is shown in blue. As the density rises it transitions through the color spectrum from light blue to green, to yellow, orange and red. FIG. 20A depicts a part manufactured using a small density multiplier. FIG. 20B depicts a part manufactured with a large density multiplier. Red indicates a larger spike in density. This raises the magnitude of the density spike on the right side faces of the part.

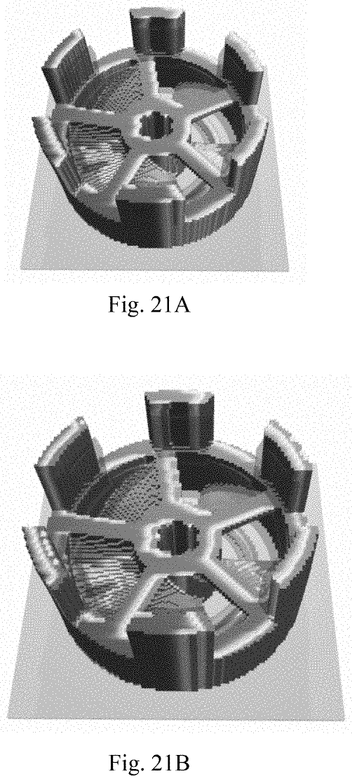

Increasing the density offset causes the density spike band to widen out. Ironically, increasing this value can cause the difference between the density spike on the leading side (right) and trailing side (left) to be more gradual, and this can cause warping to be less noticeable due to the fact that warping of a wall is caused by a large difference in densities on the front and back faces of the walls. If the density offset is increased too much, the warping effect can be mitigated during simulation. FIG. 21A depicts the use of a small density offset while FIG. 21B depicts the use of a larger density offset. The larger offset causes a wider region of high density, before decay may start.

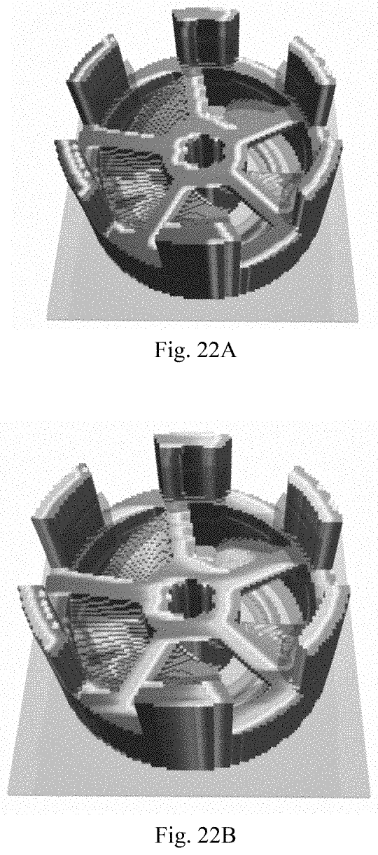

However, this will no longer simulate actual results. FIGS. 21A-B shows the effect of increasing the density decay. Increasing the density decay causes the density to more gradually return to its normal value after a spike. FIG. 22A depicts the use of a small density decay while FIG. 22B depicts the use of a large density decay. Higher density regions (red) are wider in the case of a larger decay value, causing slower decay.

Compensating for Powder Spreading Density Warp

This section of the disclosure focuses upon the modeling of density variations caused by the powder spreading process. The foregoing description in, for example, paragraphs [0147]-[0156], discloses a method for using this and other shrinkage and distortion simulation elements to simulate the overall shrinkage and distortion behavior during sintering, and then compensate for distortion by producing a negative offset shape that sinters to a straight nominal shape.

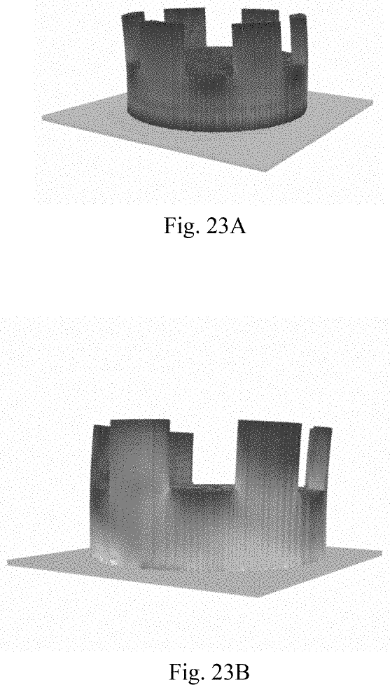

FIG. 23A depicts an initial simulation of shrinkage and warp. The walls warped left due to powder spreading density spikes. FIG. 23B depicts a negative offset part that has walls counter-offset to the right.

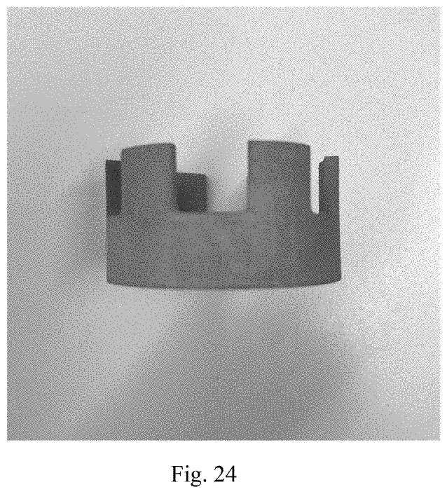

FIG. 24 is an image of a part printed using the steps of FIGS. 23A-B and includes straight walls.

Bi-Directional Powder Spreading

In addition to modeling density spikes due to powder spreading in one direction, this invention discloses a method for simulating density spikes caused by bi-directional powder spreading. With bi-directional powder spreading, a powder spreading roller may deposit layers in alternating fashion using one or more approaches. In a first approach, deposition of a first layer proceeds from right to left, followed by deposition of binder, and then a second layer is deposited left to right, followed by deposition of binder. The process then repeats. In a second approach, deposition of a first layer proceeds from right to left, followed by a deposition of a second layer left to right, followed by deposition of binder. With this approach, each layer comprises half a layer of powder spread one way with the second half spread the other. The process then repeats. A method for simulating bi-directional spreading includes first calculating the density spike components due to the distances to leading edge boundary faces in both the left and right directions. Then, to model the first approach where layers are alternating, the combined density spike at each voxel region is the average of the two individual density spikes. To model the second approach, the combined density spike at each voxel region is the maximum of the two individual density spikes.

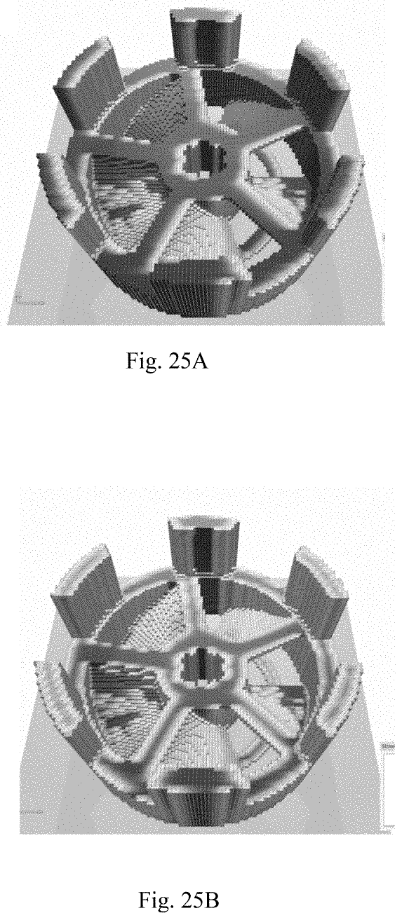

FIG. 25A depicts a density spike caused by a single direction powder spreading approach. FIG. 25B depicts a density spike caused by a bi-directional powder spreading where each layer comprises a half layer spread in one direction followed by the second half layer spread in the other direction, resulting in a combined density spike that is the max of the two.

Shrinkage Variations produced by Powder Packing

Powder packing mechanisms in 3D printers may cause gradually increasing or decreasing densities in powder that take the form of gradual increases or decreases in density as one moves around in the printed powder volume. In one example, powder at the bottom of a build volume may be packed to a higher density due to larger amounts of powder resting on top versus regions in the powder closer to the top of the build box.

One may print and sinter sample parts produced in different regions of a build, and then measure their densities. One may load this information into a database that correlates the density of the packed powder with the location within the build box.

Disclosed is a method of loading a database of position and density values that correspond to a printer and build box that is being used to simulate the shrinkage of a part during a sintering or other shrink transformation process. In the regions of a part where there is an indicated higher density, the shrink rates over time in that region may be decreased in order to simulate less shrinkage. Less shrinkage may occur in a region that has a higher initial density, as all regions may have the same final density at the end of the shrinkage process.

Shrinkage Variations Produced by Infill Patterns

Parts that are printed with infill patterns may have regions where the density of the part may be lower due to large void regions following an infill pattern such as hexagonal honeycomb volumetric cuts.

This invention discloses a method of simulating shrinkage in an area containing an infill pattern at a location within the volume of a 3D mesh. Areas containing infill are lighter and less stiff than solid areas.

Disclosed is a method of determining the presence of an infill pattern classification at a location within the volume of a 3D mesh. This may be obtained by observing the local shape of the geometry in the part to identify an infill pattern in the bounding surfaces of the part, or in the case where a part is represented as a solid mesh, the infill locations may be obtained as a list of locations and volumetric regions in the part and the associated infill classification.

Further described is a method of mapping the infill classification to a material density, which in turn is mapped to a specific particle size, mass, or particle presence. Additionally, the infill classification may be mapped to a spring-like position constraint stiffness, or presence of constraints.

As an example of a mapping, in a region where the infill classification is 50% infill, the method may determine that every other particle may be removed from the volumetric grid, and that position constraints may be applied to every other particle with double the rest length of constraints in regions where every particle is present. This skipping of particles and reducing the number of constraints may serve to model a sparse region of particle voxelization. As the part shrinks in this region, fewer particles per volume may simulate the less dense infill region. Less mass upon the structure of flexible particles and position constraints may cause the structure to deflect less in infill regions due to gravitational body forces acting on the part.

Simulation of Shrinkage

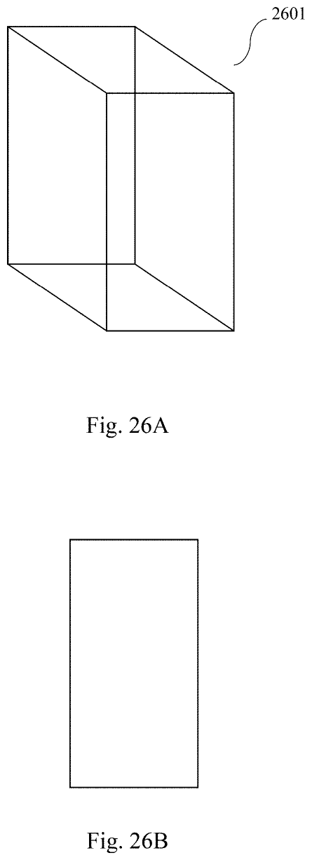

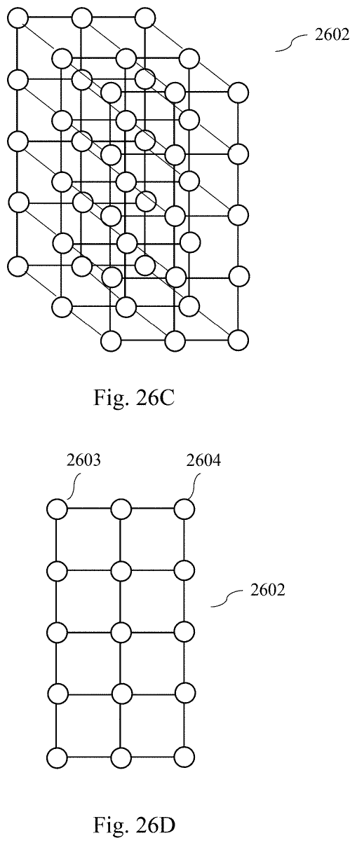

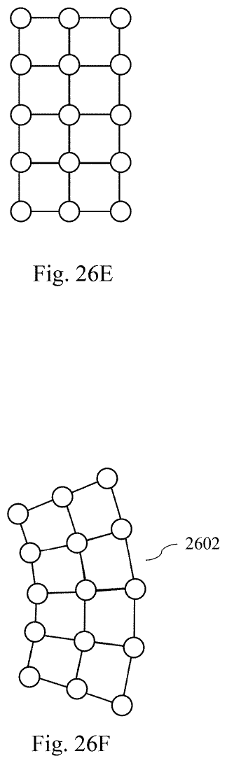

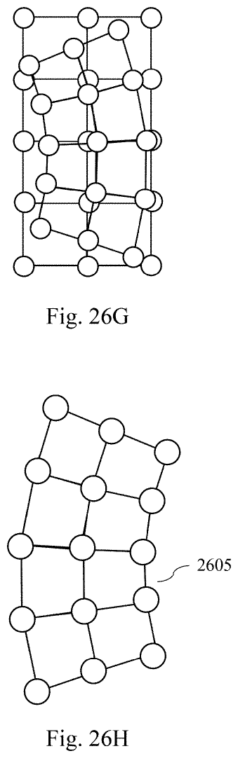

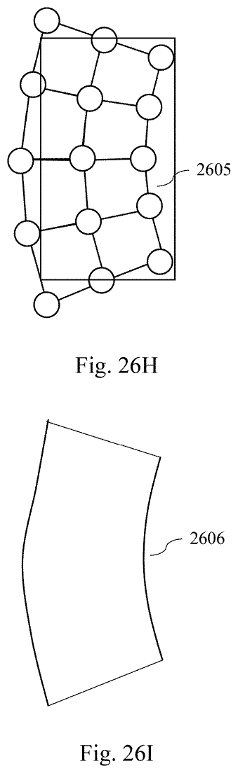

Now described is an embodiment process for compensating for shrinkage distortion caused by variations in density. With reference to FIG. 26A an initial design file is received defining an object geometry 2601. FIG. 26B shows a top view of the object geometry 2601. FIG. 26C depicts the object geometry represented as a part mesh and filled with voxels creating a voxel grid 2602. For simplicity in understanding, a plan side view (FIG. 26D) of the voxel grid 2602 is illustrated in the following figures. Each voxel including voxels 2603 and 2604 has at least one associated shrinkage coefficient. FIG. 26E shows the grid of voxels after a simulated sintering process in which all of the voxels of the voxel grid 2602 has the same shrinkage coefficient. As such the voxel grid 2602 experiences shrinkage but the overall shape of the object is maintained as evidenced by straight sides. For the final sintered part to match the desired design, a uniform scaling may be applied. However, FIG. 26F depicts the voxel grid 2602 after completion of a simulated sintering cycle wherein the voxels of the left side of object have a shrinkage coefficient that results in greater shrinkage than the voxels of the right side. The shrinkage coefficients of the voxels may be adjusted by a distortion factor (as described above) that represents a density variation induced during a powder spreading process. A sintering process may be simulated in a N number of iterative steps wherein the lengths of each of the voxel sides is computed at each time step 0→N. The length of each particular side may be calculated as: lₛ₊₁=lₛ×distortion_factor×shrink_rate where lₛ is the length from the previous iteration. The distortion factor and the shrink rate may be changed at each step. As graphically illustrated in FIG. 26G, the final simulated shrunk grid of voxels is compared to the original grid of voxels and a negative offset compensated grid of voxels may be formed that accounts for both the shrinkage inherent to the sintering process and warpage due to shrinkage variations caused by powder density variation. FIG. 26H depicts the compensated voxel grid. FIG. 26I depicts the compensated voxel grid 2605 mapped to the original part mesh. The original part mesh is then deformed according to the compensated voxel grid and into a pre-processed compensated part mesh 2606 that will result in the desired final part geometry after a sintering process.

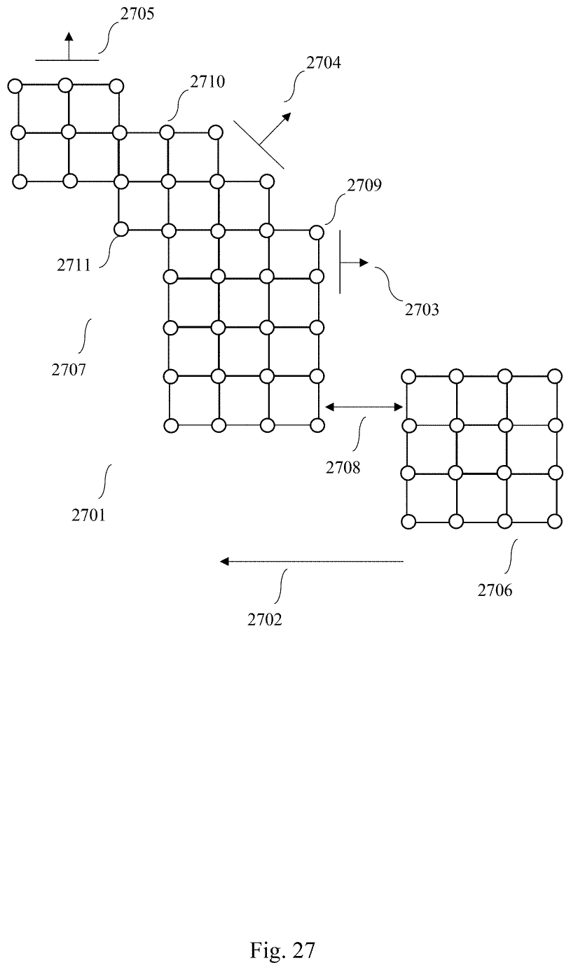

FIG. 27 depicts a top view of a grid of the voxels 2701 of a simulated part during powder spreading in a direction 2702. The opposite of the direction of powder spreading can with respect to any voxel be referred to as upstream. Voxels on faces perpendicular to direction 2702 will have an incident angle of 0° (see 2703) whereas those on a 450 face (see 2704) will have an incident angle of 45°. Voxels on faces parallel to direction 2702 (see 2705) will have an incidence angle of 90°. In FIG. 27, a first simulated object 2706 is upstream of a second simulated object 2707. Areas of the second simulated object 2707 that are downstream of the first object 2706 and within the density gap threshold distance 2708 of the first simulated object 2706 it will have a reduced distortion factor. By way of example, voxel 2709 will have a large distortion factor affecting its coefficient(s) of shrinkage because it is near the leading edge of the second simulated object 2707. In contrast, voxel 2710 will have a small distortion factor because it is far from the leading edge. Lastly, voxel 2711 will have a smaller distortion factor than voxel 2709 as its incident angle is smaller and it will experience a lesser density spike because the powder spreader is not directly hitting it.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For case of reading and clarity, certain components, modules, or methods may be described solely in connection with a specific figure. In this invention, any identification of specific techniques, arrangements, etc are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. R will be appreciated that modifications to disclosed and described examples, arrangements, configurations, components, elements, apparatuses, devices, systems, methods, etc. can be made and may be desired for a specific application. Also, for any methods described, regardless ofwhether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Throughout this invention, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code: content such as text, video data, and audio data, among others: and various codes or flags. The terms “information,” “data” and “content” are sometimes used interchangeably when permitted by context. It is intended that the specification and examples be considered

What is claimed:

1. A method of compensating for sintering warpage due to powder spreading density variations in binder jetting additive manufacturing, comprising:
receiving an initial design file defining an object geometry;
representing the object geometry as a part mesh;
filling the mesh with a grid of voxels to create a voxel grid, each voxel having at least one shrinkage coefficient;
for each voxel, determining a distortion factor caused by a powder density variation induced during a powder spreading process;
adjusting the at least one shrinkage coefficient of each voxel according to its respective distortion factor;
simulating a shrinkage of the grid of voxels according to a sintering process;
applying a negative compensation to the grid of voxels, according to the simulated shrinkage of the grid of voxels, to form a compensated grid of voxels;
mapping the change in the grid of voxels to the compensated grid of voxels onto the part mesh to create a pre-processed compensated part mesh.

2. The method of claim 1 further comprising the step of binder jetting additively manufacturing a part according to the pre-processed compensated part mesh.

3. The method of claim 1 wherein the distortion factor is determined according to:
$${D}_{F} = B \cdot {D}^{( E \cdot \frac{( F - O )}{C} )}$$
wherein:
D_{F} is a Distortion Factor is a modifier accounting for the shrinkage of a point;
B is a Density Multiplier representing the maximum spike in the density at the leading edges of transition from non-printed to printed regions;
O is a density offset representing the distance over which a density spike remains fixed at its initial value before starting to decay;
D is a density decay representing decay in the density spike;
E is the incidence angle;
F is the distance of a point downstream from an upstream transition boundary; and
C is a constant value.

4. The method of claim 1 wherein the step of determining the distortion factor includes accounting for a density gap threshold that is a distance to a next upstream wall.

5. The method of claim 1 wherein the step of determining the distortion factor includes accounting for a density height, wherein below a threshold a density buildup is zero.

6. The method of claim 1 wherein the at least one shrinkage coefficient for each voxel includes a first axis shrinkage coefficient, a second axis shrinkage coefficient and a third axis shrinkage coefficient.

7. The method of claim 2 wherein the step of binder jetting additively manufacturing the part includes bi-directional binder jetting.

8. The method of claim 7 wherein the bi-directional binder jetting includes spreading a first layer of build material powder in a first direction followed jetting a binder in a first predetermined pattern onto the first layer of build material powder and then spreading a second layer of build material powder in a second direction, opposite the first direction, followed by jetting the binder in a second predetermined pattern onto the second layer of build material powder.

9. The method of claim 8 wherein the distortion factor for each voxel is an average of two distortion factors.

10. The method of claim 2 wherein the binder jetting additively manufacturing includes, for each build layer, depositing a first layer of build material in a first direction and depositing a second layer of build material in a second direction, opposite the first direction, and depositing binder in a predetermined pattern.

11. The method of claim 10 wherein the distortion factor for each voxel is the maximum of two distortion factors.

12. A method of compensating for sintering warpage due to powder spreading density variations in binder jetting additive manufacturing, comprising:
receiving a model of a part;
adjusting the model of the part to accommodate:
an amount of shrinkage anticipated due to densification of the part during a sintering process, and
a density spike according to a density warp model of density variation caused by powder spreading in a binder jetting additive manufacturing process;
performing an iterative simulation of a sintering process on the model of the part to produce a simulated sintered geometry; and
producing a negative compensation offset according to a comparison of the simulated sintered geometry to the model of the part.

13. The method of claim 12 further comprising:
producing a production model of the part according to the negative compensation offset and the model of the part; and
binder jetting additively manufacturing a part according to the production model of the part.

14. The method of claim 12 wherein the step of adjusting the model of the part includes accounting for a density gap threshold that is a distance to a next upstream wall.

15. The method of claim 12 wherein the step of adjusting the model of the part includes accounting for a density height, wherein below a threshold a density buildup is zero.

16. The method of claim 13 wherein the step of binder jetting additively manufacturing the part includes bi-directional binder jetting.

17. The method of claim 16 wherein the bi-directional binder jetting includes spreading a first layer of build material powder in a first direction followed jetting a binder in a first predetermined pattern onto the first layer of build material powder and then spreading a second layer of build material powder in a second direction, opposite the first direction, followed by jetting the binder in a second predetermined pattern onto the second layer of build material powder.

18. The method of claim 13 wherein the binder jetting additively manufacturing includes, for each build layer, depositing a first layer of build material in a first direction and depositing a second layer of build material in a second direction, opposite the first direction, and depositing binder in a predetermined pattern.
